(19) United States
(12) Patent Application Publication
(10) Pub. No.: US 2025/0175920 A1
(43) Pub. Date: May 29, 2025

(54) METHOD AND APPARATUS FOR DETERMINING A RECEPTION TIMING OF SIGNAL IN NON-TERRESTRIAL NETWORK

(71) Applicant: Electronics and Telecommunications Research Institute, Daejeon (KR)

(72) Inventors: Jae Seung LEE, Daejeon (KR); Mi Young YUN, Daejeon (KR); Seungkwon CHO, Daejeon (KR); Moon-sik LEE, Daejeon (KR); Jun Hwan LEE, Daejeon (KR)

(21) Appl. No.: 18/964,011

(22) Filed: Nov. 29, 2024

(30) Foreign Application Priority Data
Nov. 29, 2023 (KR) 10-2023-0169959

(51) Int. Cl. H04W 56/00; H04W 24/08; H04W 84/06

(52) U.S. Cl. CPC H04W 56/0045; H04W 24/08; H04W 56/001; H04W 84/06

(57) ABSTRACT

The present disclosure provides a communication method in NTN. A method of a UE according to an exemplary embodiment of the present disclosure may comprise: receiving an SSB and SI from a first communication node of an NTN; estimating a first RTT between the UE and the first communication node; transmitting, to the first communication node, a Msg1 below a layer 2 based on a type of the first communication node indicated by the SI; in response to the type of the first communication node being a base station DU, shifting a first window for receiving a Msg2 responding to the Msg1 by the first RTT; and receiving, from the first communication node, the Msg2 including TA information based on measurement of the Msg1 and uplink grant information within the shifted first window.

### CROSS-REFERENCE TO RELATED APPLICATIONS

This application claims priority to Korean Patent Application No. 10-2023-0169959, filed on Nov. 29, 2023, with the Korean Intellectual Property Office (KIPO), the entire contents of which are hereby incorporated by reference.

### BACKGROUND

### 1. Technical Field

The present disclosure relates to a technique for receiving signals in a communication system, and more particularly, to a technique for determining a reception timing of signals in a non-terrestrial network.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a communication network can provide communication services to terminals located on the ground (terrestrial) and may be referred to as a terrestrial network. Recently, there has been a growing demand for communication services not only for terrestrial but also for non-terrestrial locations, such as unmanned aerial vehicles and satellites. In response, the 3GPP has been discussing technologies for non-terrestrial networks (NTN).

Meanwhile, in a mobile communication environment that supports NTN, when a terminal attempts to access the network, the terminal needs to use a timing different from that of a typical mobile communication environment. Additionally, in NTN, depending on a satellite architecture, for example, whether a satellite has a transparent architecture or a regenerative architecture, the terminal needs to adjust its network access timing accordingly.

However, specific methods for such access timing have not yet been proposed.

### SUMMARY

The present disclosure for resolving the above-described problems is directed to providing a method and an apparatus for determining an access timing of a terminal in a mobile communication environment supporting NTN.

A method of a user equipment (UE), according to an exemplary embodiment of the present disclosure for achieving the above-described objective, may comprise: receiving a synchronization signal block (SSB) and system information (SI) from a first communication node of a non-terrestrial network; estimating a first round trip time (RTT) between the UE and the first communication node; transmitting, to the first communication node, a first message (Msg1) below a layer 2 at a first transmission time based on a type of the first communication node indicated by the SI and the first RTT; in response to the type of the first communication node being a regenerative satellite in form of a base station distributed unit (DU), shifting a first window for receiving a second message (Msg2) responding to the Msg1 by the first RTT; and receiving, from the first communication node, the Msg2 including timing advance (TA) information based on measurement of the Msg1 and uplink grant information within the shifted first window.

The first RTT may be calculated based on at least: a first parameter based on a delay between the first communication node and a reference point (RP), a UE-specific TA value obtained based on an ephemeris-related parameter broadcast by the satellite and location information of the UE, a TA offset, or a second parameter for alignment of an uplink radio frame and a downlink radio frame, which is broadcast by the satellite.

The method may further comprise: in response to the type of the first communication node being a regenerative satellite in form of a base station DU, transmitting, to a terrestrial base station central unit (CU), a third message (Msg3) including a radio resource control (RRC) layer message via the first communication node based on the uplink grant information; calculating a second RTT between the UE and the terrestrial base station CU based on the SI or the Msg2; shifting a second window for receiving a fourth message (Msg4) responding to the Msg3 by the second RTT; and receiving the Msg4 within the second window shifted by the second RTT.

The second RTT may be calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the first communication node.

The method may further comprise: in response to the type of the first communication node being a satellite including a full base station, shifting a first window for receiving an Msg2 responding to the Msg1 by the first RTT; and receiving the Msg2 within the shifted first window from the first communication node.

The method may further comprise: in response to the type of the first communication node being a satellite including a full base station; transmitting, to the first communication node, an Msg3 including an RRC layer message based on the uplink grant information; shifting a second window for receiving an Msg4 responding to the Msg3 by the first RTT; and receiving the Msg4 within the second window shifted by the first RTT.

The method may further comprise: in response to the type of the first communication node being a terrestrial relay node operating as a base station DU, receiving the Msg2 within the first window for receiving the Msg2.

The method may further comprise: in response to the type of the first communication node being a terrestrial relay node operating as a base station DU, transmitting, to a base station CU, an Msg3 including an RRC layer message via the first communication node based on the uplink grant information; calculating a second RTT between the UE and the base station CU based on the SI or the Msg2; shifting a second window for receiving an Msg4 responding to the Msg3 by the second RTT; and receiving the Msg4 within the second window shifted by the second RTT.

The second RTT may be calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the satellite.

A user equipment (UE) according to an exemplary embodiment of the present disclosure may comprise at least one processor, and the at least one processor may cause the UE to perform: receiving a synchronization signal block (SSB) and system information (SI) from a first communication node of a non-terrestrial network; estimating a first round trip time (RTT) between the UE and the first communication node; transmitting, to the first communication node, a first message (Msg1) below a layer 2 at a first transmission time based on a type of the first communication node indicated by the SI and the first RTT; in response to the type of the first communication node being a regenerative satellite in form of a base station distributed unit (DU), shifting a first window for receiving a second message (Msg2) responding to the Msg1 by the first RTT; and receiving, from the first communication node, the Msg2 including timing advance (TA) information based on measurement of the Msg1 and uplink grant information within the shifted first window.

The first RTT may be calculated based on at least: a first parameter based on a delay between the first communication node and a reference point (RP), a UE-specific TA value obtained based on an ephemeris-related parameter broadcast by the satellite and location information of the UE, a TA offset, or a second parameter for alignment of an uplink radio frame and a downlink radio frame, which is broadcast by the satellite.

The at least one processor may further cause the UE to perform: in response to the type of the first communication node being a regenerative satellite in form of a base station DU, transmitting, to a terrestrial base station central unit (CU), a third message (Msg3) including a radio resource control (RRC) layer message via the first communication node based on the uplink grant information; calculating a second RTT between the UE and the terrestrial base station CU based on the SI or the Msg2; shifting a second window for receiving a fourth message (Msg4) responding to the Msg3 by the second RTT; and receiving the Msg4 within the second window shifted by the second RTT.

The second RTT may be calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the first communication node.

The at least one processor may further cause the UE to perform: in response to the type of the first communication node being a satellite including a full base station, shifting a first window for receiving an Msg2 responding to the Msg1 by the first RTT; and receiving the Msg2 within the shifted first window from the first communication node.

The at least one processor may further cause the UE to perform: in response to the type of the first communication node being a satellite including a full base station; transmitting, to the first communication node, an Msg3 including an RRC layer message based on the uplink grant information; shifting a second window for receiving an Msg4 responding to the Msg3 by the first RTT; and receiving the Msg4 within the second window shifted by the first RTT.

The at least one processor may further cause the UE to perform: in response to the type of the first communication node being a terrestrial relay node operating as a base station DU, receiving the Msg2 within the first window for receiving the Msg2.

The at least one processor may further cause the UE to perform: in response to the type of the first communication node being a terrestrial relay node operating as a base station DU, transmitting, to a base station CU, an Msg3 including an RRC layer message via the first communication node based on the uplink grant information; calculating a second RTT between the UE and the base station CU based on the SI or the Msg2; shifting a second window for receiving an Msg4 responding to the Msg3 by the second RTT; and receiving the Msg4 within the second window shifted by the second RTT.

The second RTT may be calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the satellite.

A method of a satellite, according to an exemplary embodiment of the present disclosure for achieving the above-described objective, may comprise: broadcasting a synchronization signal block (SSB) and system information (SI) within a cell; and in response to receipt of a first message (Msg1) below a second layer (layer 2) from a user equipment (UE), transmitting, to the UE, a second message (Msg2) including timing advance (TA) information based on measurement of the Msg1 and uplink grant information, wherein the SI indicates type information of the satellite, and the type information indicates that the satellite is a regenerative satellite in form of a base station distributed unit (DU).

The method may further comprise: in response to receipt of a third message (Msg3) including a radio resource control (RRC) layer message from the UE, forwarding the Msg3 to a terrestrial base station in form of a central unit (CU); and in response to receipt of a fourth message (Msg4) responding to the Msg3 from the terrestrial base station in form of the CU, transmitting the Msg4 to the UE.

According to exemplary embodiments of the present disclosure, when a satellite in a non-terrestrial network includes the entirety or a part of a base station, a UE can determine a transmission and reception timing of signals based on a hierarchical configuration of the base station included in the satellite and transmit and receive signals accordingly. Furthermore, when a terrestrial relay node is used, not only NTN terminals but also terminals that do not support NTN functionality can access an NTN through the terrestrial relay node. In such cases, both NTN terminals and terminals without NTN functionality can determine a transmission and reception timing of signals based on the hierarchical configuration of the base station and transmit and receive signals accordingly. Accordingly, there is an advantage in that the non-terrestrial network can be implemented in various forms.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4A is a conceptual diagram illustrating a first exemplary embodiment of a transparent satellite-based NG-RAN architecture under standardization in 3GPP.

FIG. 4B is a conceptual diagram illustrating an exemplary embodiment of an NG-RAN for a case where a full base station is included in a satellite in an NTN architecture.

FIG. 4C is a conceptual diagram illustrating an exemplary embodiment of an NG-RAN in which a satellite includes a gNB-DU, and a ground station includes a gNB-CU in an NTN.

FIG. 5 is a conceptual diagram illustrating a timing between a downlink radio frame and an uplink radio frame in 5G NR.

FIG. 6 is a conceptual diagram illustrating delays and a timing relationship in an NTN.

FIG. 7 is a timing diagram illustrating an example of a four-step random access procedure in case of TN in a 5G NR system.

FIG. 8A is a simplified conceptual diagram illustrating an NTN architecture with a transparent satellite.

FIG. 8B is a simplified conceptual diagram illustrating an NTN architecture that includes a relay node capable of communicating with a transparent satellite.

FIG. 9A is a simplified conceptual diagram illustrating an NTN architecture with a full base station-based regenerative satellite.

FIG. 9B is a simplified conceptual diagram illustrating an NTN architecture that includes a relay node capable of communicating with a full base station-based regenerative satellite.

FIG. 10A is a simplified conceptual diagram illustrating an NTN architecture with a gNB-DU-based regenerative satellite.

FIG. 10B is a simplified conceptual diagram illustrating an NTN architecture that includes a relay node capable of communicating with a gNB-DU-based regenerative satellite.

FIG. 11 is a timing diagram illustrating a random access procedure in NTN with a transparent satellite.

FIG. 12 is a conceptual diagram illustrating delays in an NTN where a satellite includes a gNB-DU, and a gNB-CU is located on the ground.

FIG. 13 is a timing diagram illustrating a random access procedure in an NTN with an IAB architecture where a satellite includes a gNB-DU, and a gNB-CU is located on the ground.

FIG. 14 is a conceptual diagram illustrating a delay in a case where a UE communicates with an NTN having a transparent satellite via a relay node.

FIG. 15 is a timing diagram illustrating a random access procedure performed by a UE to a base station via a relay node in an NTN with a transparent satellite.

FIG. 16 is a conceptual diagram illustrating delays when a UE communicates with an NTN via a terrestrial relay node in a case where the NTN comprises a regenerative satellite including a gNB-DU and a terrestrial gNB-CU.

FIG. 17 is a timing diagram illustrating a random access procedure for an NTN having a satellite DU and a terrestrial CU via a terrestrial relay node.

FIG. 18 is a conceptual diagram illustrating delays when a UE communicates with an NTN via a relay node in a case where a satellite in the NTN includes a full gNB.

FIG. 19 is a timing diagram illustrating a procedure for a UE to perform random access via a relay node in an NTN architecture where a satellite includes a full gNB.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure describe in greater detail with reference to the accompanying drawings. In order to facilitate general understanding in describing the present disclosure, the same components in the drawings are denoted with the same reference signs, and repeated descriptions thereof are omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

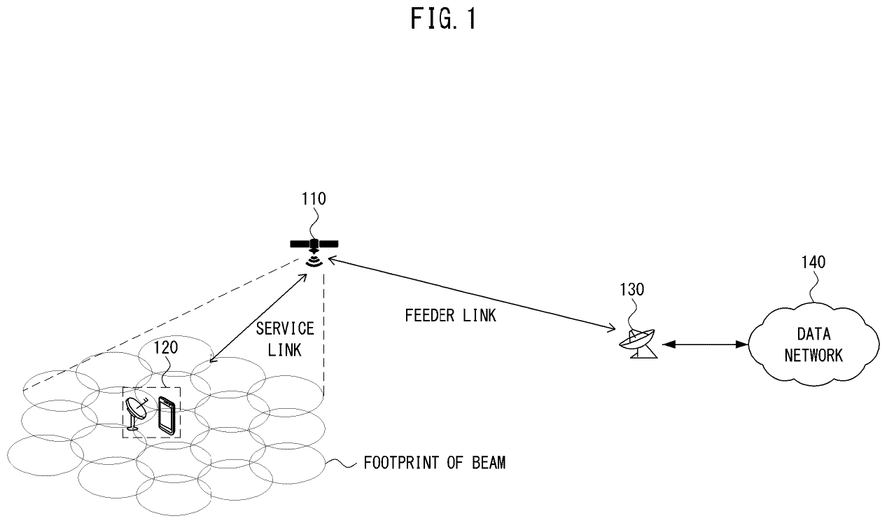

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

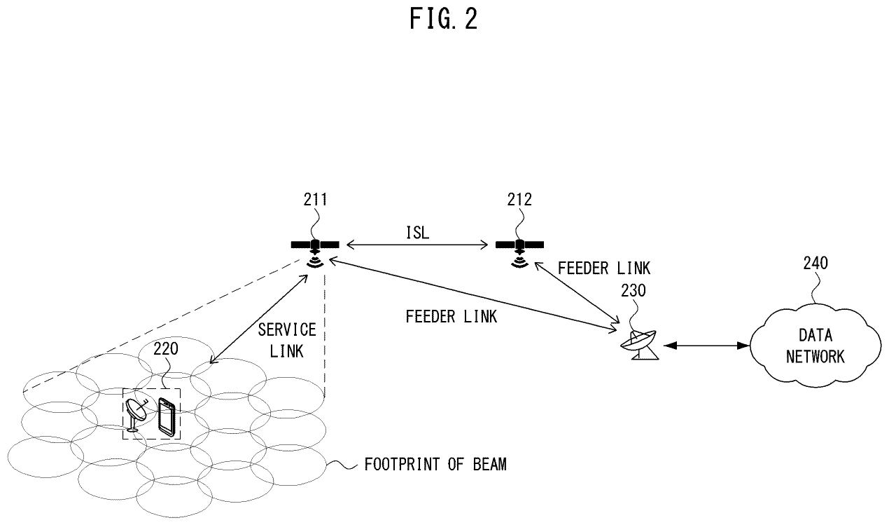

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

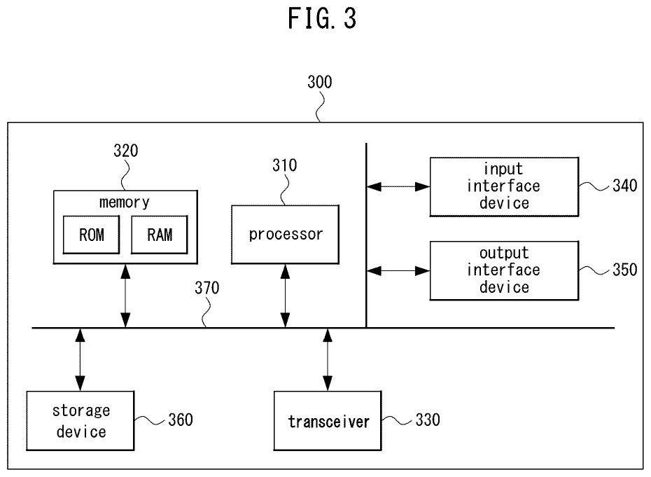

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel | 30 MHz for band <6 GHz | |
| bandwidth capability | 1 GHz for band >6 GHz | |
| (service link) | | |
| Maximum distance between | 40,581 km | 1,932 km (altitude of 600 km) |
| satellite and communication | | 3,131 km (altitude of 1,200 |
| node (e.g. UE) at the | | km) |
| minimum elevation angle | | |
| Maximum round trip delay | Scenario A: 541.46 ms | Scenario C: (transparent |
| (RTD) | (service and feeder links) | payload: service and feeder |
| (only propagation delay) | Scenario B: 270.73 ms (only | links) |
| | service link) | 5.77 ms (altitude of 60 0 km) |
| | | 41.77 ms (altitude of 1,200 |
| | | km) |
| | | Scenario D: (regenerative |
| | | payload: only service link) |
| | | 12.89 ms (altitude of 600 |
| | | km) |
| | | 20.89 ms (altitude of 1,200 |
| | | km) |
| Maximum delay variation | 16 ms | 4.44 ms (altitude of 600 km) |
| within a single beam | | 6.44 ms (altitude of 1,200 km) |
| Maximum differential delay | 10.3 ms | 3.12 ms (altitude of 600 km) |
| within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a | 541.75 ms | 270.57 ms | 28.41 ms | 12.88 ms |
| radio interface between | (worst case) | | | |
| base station and UE | | | | |
| Minimum RTD in a | 477.14 ms | 238.57 ms | 8 ms | 4 ms |
| radio interface between | | | | |
| base station and UE | | | | |

Meanwhile, the 3GPP has been advancing the standardization of 5G NR-based NTN since 2017.

The 3GPP NTN architecture may largely be categorized into the following two configurations. First, the 3GPP NTN architecture may adopt an NTN architecture with a transparent satellite-based NG-RAN architecture. Second, the 3GPP NTN architecture may adopt an NG-RAN architecture that includes a regenerative satellite equipped with a gNB-distributed unit (gNB-DU) or a full gNB.

The transparent satellite-based NG-RAN architecture may resemble the form illustrated in FIG. 1. More specific configurations are described with reference to the attached drawings.

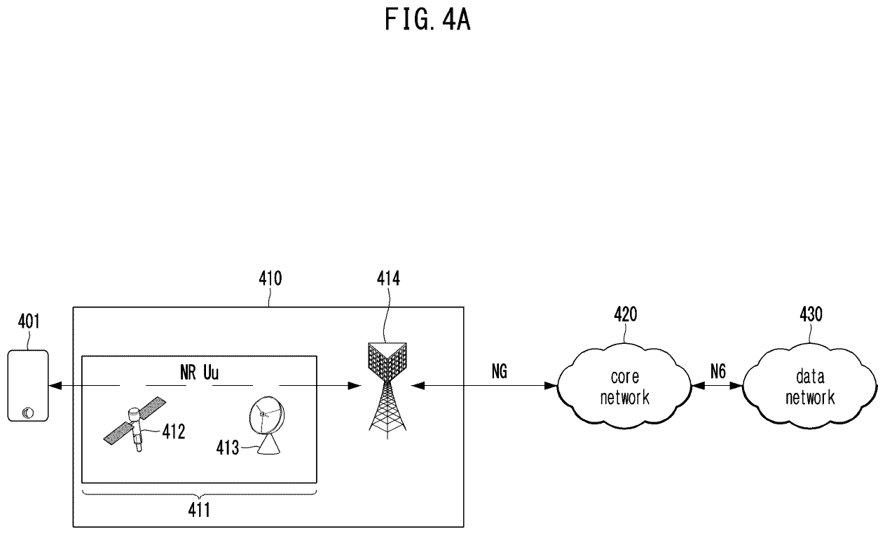

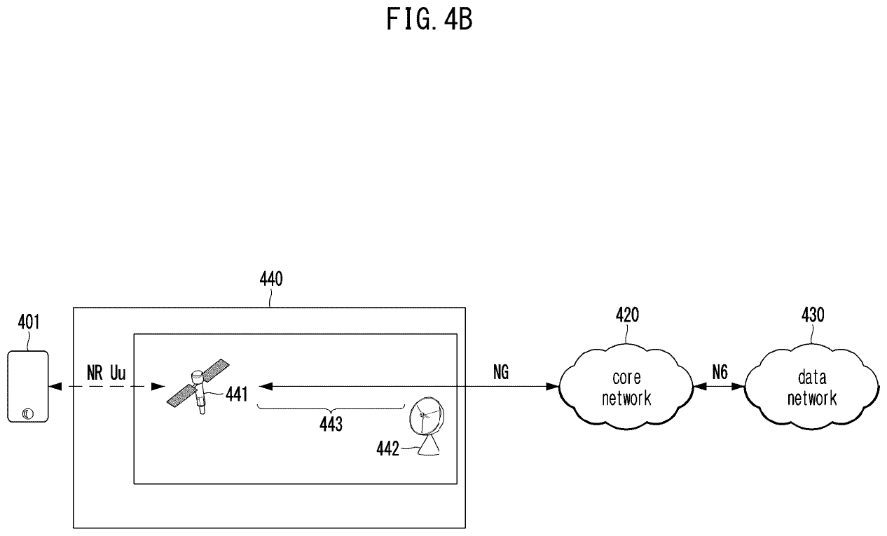

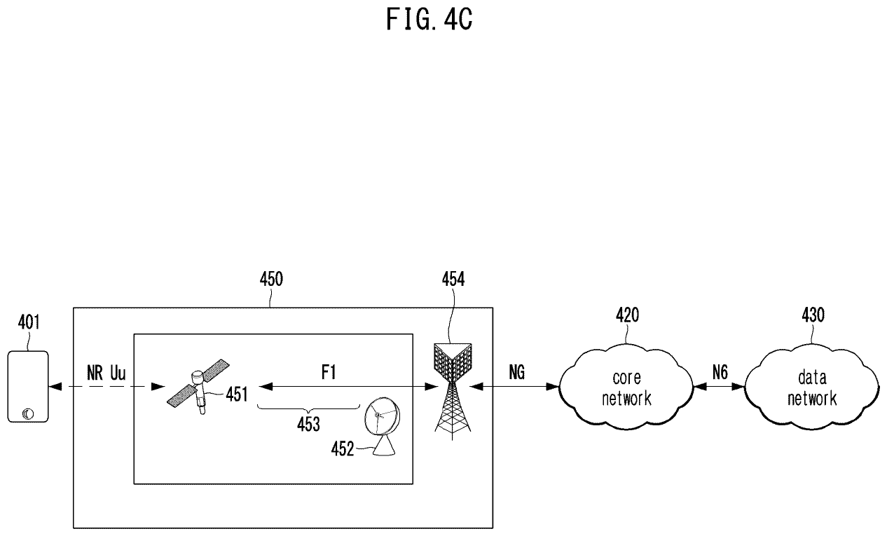

FIG. 4A is a conceptual diagram illustrating a first exemplary embodiment of a transparent satellite-based NG-RAN architecture under standardization in 3GPP.

Referring to FIG. 4A, the transparent satellite-based NG-RAN architecture may include a user equipment (UE) 401, an NG-RAN 410, a core network 420, and a data network 430. Additionally, the NG-RAN 410 may include a transparent satellite 412, an NTN gateway 413, and a base station 414. The base station 414 may provide a connection between the NTN gateway 413 and the core network 420. Here, the core network 420 may, for example, be a core network of a 5G NR system.

The transparent satellite 412 may perform only a role of an RF amplifier and may perform frequency conversion. In other words, the transparent satellite 412 may operate as an analog RF repeater. The NTN gateway 413 may provide a function for forwarding signals of a 3GPP NR-Uu interface. Accordingly, the transparent satellite 412 may forward signals and/or data transmitted using the NR-Uu radio interface over a feeder link and a service link. In other words, both the service link and feeder link may use the NR-Uu interface. Therefore, from a logical perspective, the transparent satellite 412 and NTN gateway 413 may be regarded as a remote radio unit (RRU) 411 for the 5G NR base station (gNB) 414.

Each link from the base station 414 to the UE 401 may use the NR-Uu interface, as illustrated in FIG. 4A. Additionally, an NG protocol may be used between the base station 414 and the core network 420, and an N6 interface may be used between the core network 420 and the data network 430.

Meanwhile, standardization of NTN architectures incorporating a regenerative satellite is planned for the future. In the NTN structures with a regenerative satellite, a satellite payload may regenerate signals received from the ground and transmit the signals to the UE. The NTN architectures with the regenerative satellite may fall into one of the following two categories.

First, a full base station (i.e. full gNB) may be located on the satellite. Second, the base station (gNB) may be split into a central unit (CU) and a distributed unit (DU), where the gNB-CU is located on the ground and the gNB-DU is located on the regenerative satellite. The NTN architectures with the regenerative satellite are further described with reference to the attached drawings.

FIG. 4B is a conceptual diagram illustrating an exemplary embodiment of an NG-RAN for a case where a full base station is included in a satellite in an NTN architecture.

Referring to FIG. 4B, a UE 401, an NG-RAN 440, a core network 420, and a data network 430 are illustrated. Additionally, the NG-RAN 440 may include a regenerative satellite 441 and an NTN gateway 442. Therefore, unlike FIG. 4A, in FIG. 4B, the NTN gateway 442 may be directly connected to the core network 420. Alternatively, although not illustrated in FIG. 4B, the NTN gateway 442 may be connected to the core network 420 through a base station for connectivity between the gateway and the core network. Here, the core network 420 may, for example, be a core network of a 5G NR system.

The exemplary embodiment of FIG. 4B may correspond to a case where the regenerative satellite 441 includes a full gNB. Accordingly, the regenerative satellite 441 may perform all functions of a base station. The regenerative satellite 441 may use an NR-Uu interface for communication with the UE 401. Additionally, communication 443 between the regenerative satellite 441 and the NTN gateway 442 may use an NG (over NG) protocol through a satellite radio interface (SRI). Here, the SRI may serve as a transport link between the NTN gateway 442 and the regenerative satellite 441. In other words, a service link may use the NR-Uu interface, while a feeder link may use the NG protocol over the SRI. Furthermore, although FIG. 4B illustrates only a single satellite, as described with reference to FIG. 2, inter-satellite links (ISLs) may be used for communications between multiple satellites. The NTN gateway 442 illustrated in FIG. 4B may function as a transport network layer (TNL) node and may use a transport protocol.

FIG. 4C is a conceptual diagram illustrating an exemplary embodiment of an NG-RAN in which a satellite includes a gNB-DU, and a ground station includes a gNB-CU in an NTN.

Referring to FIG. 4C, a UE 401, an NG-RAN 450, a core network 420, and a data network 430 are illustrated. The NG-RAN 450 may include a regenerative satellite 451, an NTN gateway 452, and a base station 454. The regenerative satellite 451 may include a gNB-DU, and the base station 454 may be configured as a gNB-CU. The base station 454 may connect the NTN gateway 452 and the core network 420. The core network 420 may, for example, be a core network of a 5G NR system.

A service link between the regenerative satellite 451 and the UE 401 may use an NR-Uu interface as described previously. A feeder link between the regenerative satellite 451 and the NTN gateway 452 may use an F1 protocol over an SRI. The F1 protocol may be a protocol used between the gNB-CU and gNB-DU. Therefore, the SRI may transport the F1 protocol on the feeder link.

Although FIG. 4C illustrates a single satellite, as described with reference to FIG. 2, two or more satellites may communicate using ISLs. In this case, each of the two or more satellites may be a satellite equipped with a DU. Furthermore, the two or more satellites, each equipped with a DU, may connect to the single gNB-CU 454, as illustrated in FIG. 4C. Additionally, the NTN gateway 452 may function as a TNL node and may use a transport protocol.

In the present disclosure described below, NTN nodes may collectively refer to aerial vehicles such as satellites and other high-altitude platform stations (HAPS). The HAPS may include various types of high-altitude stations used for weather monitoring, wireless relays, oceanography, earth imaging, border security, maritime patrol, anti-piracy operations, disaster response, or agricultural observation. Therefore, in the descriptions below, NTN nodes or satellites should be understood to include not only satellites but also HAPS.

The NTN described above has a much longer propagation time than a terrestrial network (TN). Therefore, extension of a timing relationship in TN is required, and the 3GPP, which is standardizing 5G NR, defines such an extension.

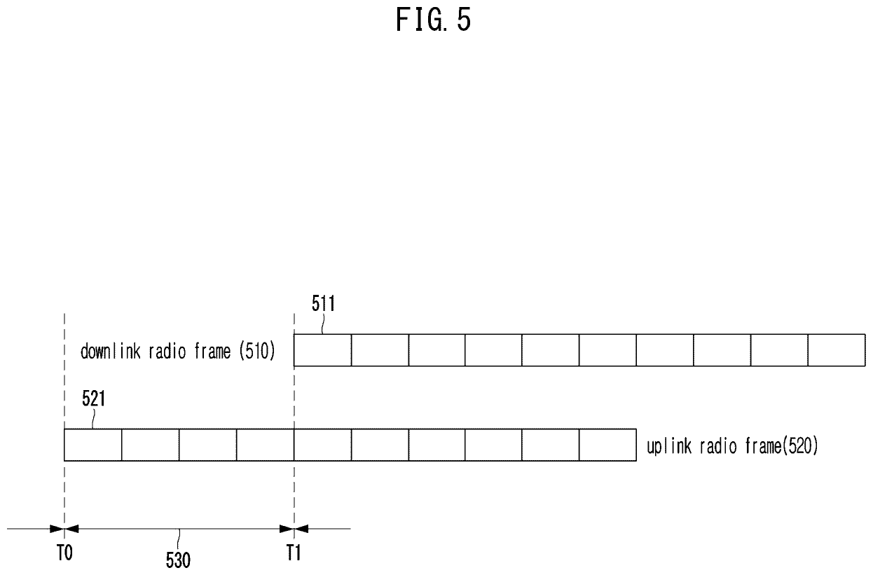

FIG. 5 is a conceptual diagram illustrating a timing between a downlink radio frame and an uplink radio frame in 5G NR.

Referring to FIG. 5, a first slot 511 of a downlink radio frame 510 may be transmitted at a time T1, and a first slot 521 of an uplink radio frame 520 may be transmitted at a time TO. As illustrated in FIG. 5, a transmission time of the first slot 521 of the uplink radio frame 520 is earlier than a transmission time of the first slot 511 of downlink radio frame 510. A time interval from T0 to T1 may vary depending on a distance between the UE and gNB. Uplink transmission in an uplink slot earlier than the time T1, such as at the time T0, is required to align the uplink radio frame with the downlink radio frame. In other words, the uplink radio frame 520 transmitted by the UE may need to start earlier to compensate for a propagation delay corresponding to the distance between the UE and the gNB and synchronize with the downlink radio frame 510.

To synchronize the downlink radio frame 510 and the uplink radio frame 520, timing information that enables the uplink radio frame 520 to be transmitted earlier is referred to as a Timing Advance (TA). Typically, the TA value may be determined by the gNB. For example, when the UE transmits a specific signal to the gNB, the gNB may measure a delay of the signal received from the UE and provide N_{TA} corresponding to the measured delay to the UE. Additionally, the gNB may further provide N_{TA,offset} for correcting N_{TA} to the UE. N_{TA,offset} may be a fixed value determined by factors such as a frequency band, a duplex mode, or coexistence with LTE. Therefore, the UE may determine an uplink transmission time using N_{TA} and N_{TA,offset} received from the gNB. In the case of a terrestrial network, the UE may need to determine a transmission time T_{TA} 530 for uplink transmission before performing the uplink transmission. T_{TA} may be calculated as shown in Equation 1 below.

$${T}_{TA} = ( {N}_{TA} + {N}_{TA , offset} ) \times {T}_{c} \qquad [ Equation 1 ]$$

In Equation 1, Tc may refer to a basic time unit of NR. In the example of FIG. 5, T_{TA} 530 is assumed to correspond to four slots, but this should be noted as an example for ease of understanding.

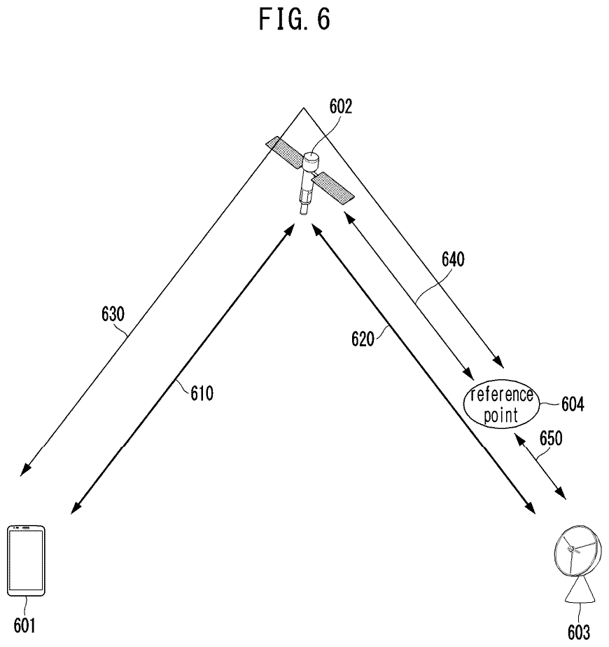

FIG. 6 is a conceptual diagram illustrating delays and a timing relationship in an NTN.

Referring to FIG. 6, a satellite 602 may transmit and receive signals (or data) with a UE 601 through a service link 610, and the satellite 602 may also transmit and receive signals (or data) with an NTN gateway 603 through a feeder link 620. Therefore, a round trip time (RTT) between the UE 601 and satellite 602 may be determined based on a distance of the service link 610 between the UE 601 and satellite 602. Additionally, an RTT between the satellite 602 and NTN gateway 603 may be determined based on a distance of the feeder link 620 between the satellite 602 and NTN gateway 603. In this case, it is assumed that a base station (gNB) is located at the same site as the NTN gateway 603 or directly connected to the NTN gateway 603, allowing a time delay to be ignored.

Based on the above assumption, a delay in NTN is compared with a delay in TN below.

First, in the case of NTN, a delay between the gNB and UE 601 may be a sum of the RTT of the service link 610 and the RTT of the feeder link 620. On the other hand, in the case of TN, a delay between the gNB and UE may occur based on a distance between the gNB and UE. Typically, a distance from the ground to the satellite 602 in NTN is longer than a cell radius of a base station in TN. Therefore, a delay of the service link 610 between the UE 601 and satellite 602 may be significantly longer than a delay from the UE to the base station in TN. The satellite 602 also has the feeder link 620 with the NTN gateway 603 located on the ground. Since the feeder link 620 is a link between the satellite 602 and the ground NTN gateway 603, the delay of the feeder link 620 may also be significantly longer than the delay from the UE to the base station in TN. Accordingly, the delays of the service link 610 and feeder link 620 may vary depending on the altitude of the satellite.

As such, in the case of NTN, it is required to consider not only the delay of the service link 610 but also the delay of the feeder link 620. To address these issues, the 3GPP has extended the timing relationships applied in 5G TN to NTN.

First, in TN, as described above with reference to FIG. 5, the parameters N_{TA} and N_{TA,offset} are specified to synchronize the timings of the downlink radio frame and uplink radio frame between the base station and UE. The UE may acquire the parameter N_{TA} from the gNB in a random access procedure. For example, when the UE transmits a first message (message 1, Msg1) to the gNB in the random access procedure, the gNB may measure a delay of Msg1 and transmit the parameter N_{TA} to the UE as compensation information. When a four-step random access procedure is performed, the parameter N_{TA} may be included in a second message (message 2, Msg2) and provided to the UE. When a two-step random access procedure is performed, the parameter N_{TA} may be included in a second message (message B, msgB) and provided to the UE.

After initial access, the parameter N_{TA} may be updated through a TA command in a medium access control-control element (MAC-CE).

In NTN, in addition to the parameters used in TN (i.e. N_{TA} and N_{TA,offset}), additional parameters have been defined: a common TA, referred to as N_{TA,adj}^{common}, and a UE-specific TA, referred to as N_{TA,adj}^{UE}.

The parameter N_{TA,adj}^{common}, referred to as the common TA, may be a timing offset set to a value corresponding to an RTT between a reference point (RP) 604 and the NTN payload. The parameter N_{TA,adj}^{common} may be used to pre-compensate for a bidirectional transmission delay between the reference point 604 and satellite 602. The reference point 604 may be a specific location between the satellite 602 and gateway 603, which is configured by the network. The reference point 604 may also be located on the satellite 602 or on a base station (not shown in FIG. 6). At the reference point 604, transmission and reception timings of the uplink radio frame and the downlink radio frame may be aligned. Therefore, the reference point 604 may represent a value commonly applied to all UEs. The parameter N_{TA,adj}^{common} may, for example, be configured by the gNB and transmitted to the UE. The parameter N_{TA,adj}^{common} common may be derived based on delay-related information such as parameters TACommon, TACommonDrift, and TACommonDriftVariation of higher-layer message(s).

The parameter N_{TA,adj}^{UE} may correspond to the RTT of the service link 610 between the UE 601 and satellite 602. Therefore, the parameter N_{TA,adj}^{UE} may be estimated by the UE itself and used to pre-compensate for the service link delay. The UE may calculate the parameter N_{TA,adj}^{UE} using the UE's location information obtained via a global navigation satellite system (GNSS) and satellite ephemeris-related information provided by the network.

In the connected mode, the UE may continuously update the TA. The UE may be configured to report the TA value to the gNB either during the random access procedure or in the connected mode. If the UE is configured to report the TA value to the gNB during the random access procedure or in the connected mode, the UE may report the TA value to the gNB either at a configured time or based on a reporting command from the gNB.

In NTN, a parameter K_{offset} has been introduced to ensure that the UE has a sufficient processing time between downlink reception and uplink transmission. The parameter K_{offset} may be configured by the gNB and transmitted to the UE. The parameter K_{offset}, also referred to as a configured scheduling offset, may be set to a value equal to or greater than a sum of the RTT of the service link 610 and the common TA. When the UE receives DCI for scheduling transmission of a physical uplink shared channel (PUSCH), the UE may transmit the PUSCH by shifting a slot for transmitting the PUSCH by K_{offset} from a typical timing in TN.

In the initial random access, the UE may use a cell-specific K_{offset} provided by the gNB through system information. After the initial access, the UE may receive a UE-specific K_{offset} from the gNB through a MAC CE. The UE-specific K_{offset} may refer to a parameter K_{offset} configured differently for each UE. Therefore, after the initial random access, if the UE receives a UE-specific K_{offset} from the gNB, the UE may update the cell-specific K_{offset} obtained from system information with the UE-specific K_{offset}.

Using the parameters described above for NTN, a time T_{TA} determined by the UE for uplink transmission to align the downlink radio frame and uplink radio frame is described with reference to FIG. 5.

In FIG. 5, the downlink radio frame 510 may be transmitted from the gNB to the UE through the satellite, and the uplink radio frame 520 may be transmitted from the UE 601 to the gNB through the satellite. Therefore, the UE 601 may calculate T_{TA} for uplink transmission using the parameters described above, as shown in Equation 2.

$${T}_{TA} = ( {N}_{TA} + {N}_{TA , offset} + {N}_{TA , adj}^{common} + {N}_{TA , adj}^{UE} ) \times {T}_{c} \qquad [ Equation 2 ]$$

In NTN, as described above, the gNB may provide the parameters N_{TA,adj}^{common} and N_{TA,adj}^{UE} in addition to the parameters N_{TA} and N_{TA,offset}. The parameter N_{TA,adj}^{common}, a value set between the satellite 602 and reference point 604 in NTN, may be a parameter commonly applied to all UEs. The parameter N_{TA,adj}^{UE}, a value set based on a distance between the satellite 602 and UE 601, may be a parameter configured differently for each UE. Therefore, the UE 601 may determine T_{TA} for uplink transmission using Equation 2.

Additionally, the gNB providing the parameters used in Equation 2 to the UE 601 may broadcast valid ephemeris information and common TA-related parameters for a serving cell. Accordingly, the UE may calculate the RTT between the UE and the reference point 604 based on the UE's GNSS position, the broadcast ephemeris and common TA-related parameters for synchronization with the NTN cell. The UE 601 may also calculate T_{TA} and pre-compensate a start time of the uplink radio frame transmission based on T_{TA}.

Meanwhile, in NTN, an additional parameter k_{mac} is defined to align the uplink and downlink radio frames. The parameter k_{mac} may be used to delay an application time of a configuration indicated by a MAC CE command received through a physical downlink shared channel (PDSCH). The parameter k_{mac} may be configured by the gNB and provided to the UE. The parameter k_{mac} may be set to a value equal to the RTT between the reference point 604 and the gNB. Although FIG. 6 does not explicitly illustrate the gNB, it may be assumed that the gNB is located at the same site as the NTN gateway 603 or directly connected to the NTN gateway 603. Therefore, in the example of FIG. 6, the parameter k_{mac} may correspond to a reference numeral 650.

The parameter k_{mac} may be applied in cases where the timing of uplink radio frame transmission adjusted using the parameters described above does not align with the timing of downlink radio frame transmission. The parameter k_{mac} may be a slot-level parameter provided by the gNB to the UE. If the parameter k_{mac} is not provided by the gNB, the UE may assume k_{mac} to be zero.

Considering the parameter k_{mac} provided in NTN, the RTT between the UE and gNB may be calculated as shown in Equation 3.

$$RTT between UE and gNB = {T}_{TA} + {k}_{mac} = ( {N}_{TA} + {N}_{TA , offset} + {N}_{TA , adj}^{common} + {N}_{TA , adj}^{UE} ) \times {T}_{c} + {K}_{mac} \qquad [ Equation 3 ]$$

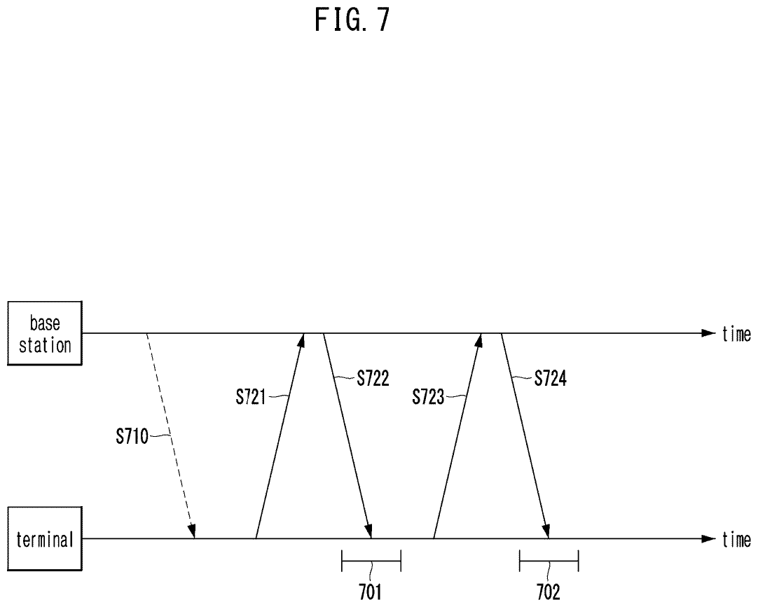

FIG. 7 is a timing diagram illustrating an example of a four-step random access procedure in case of TN in a 5G NR system.

Referring to FIG. 7, in step S710, a base station may broadcast synchronization signals and system information within its communication coverage. In the 5G NR system, the base station may broadcast synchronization signal blocks (SSBs) and/or physical broadcast channels (PBCHs). The SSB may include synchronization signals and the PBCH. Additionally, system information may refer to various types of system information blocks, such as SIB1 and SIB2. Accordingly, in step S710, the UE may receive the SSB and/or PBCH broadcast by the base station and acquire downlink synchronization based on the SSB. The UE may also obtain SIB1 based on a master information block (MIB) included in the PBCH received in step S710.

In step S721, the UE may transmit a first message (message 1, Msg1) to the base station to acquire uplink synchronization. Msg1 may be configured as a preamble for random access. At this time, the UE may set N_{TA} to 0 when transmitting Msg1.

In step S721, the base station may receive Msg1 transmitted by the UE. Msg1 received by the base station in step S721 may have been transmitted by the UE without any pre-compensation. Therefore, the base station receiving Msg1 transmitted by the UE may estimate N_{TA} based on the received Msg1.

In step S722, the base station may transmit a second message (message 2, Msg2) to the UE in response to Msg1 received from the UE. Msg2 may be a random access response (RAR). Msg2 may include N_{TA} estimated by the base station and uplink grant information for transmission of a third message (i.e. message 3, Msg3). The uplink grant information may be uplink resource allocation information.

In step S722, the UE may receive Msg2 from the base station. The UE may receive Msg2 within an RAR window 701. If the UE fails to receive Msg2 within the RAR window 701, the UE may determine that the random access procedure has failed. Since the example in FIG. 7 illustrates a procedure where all steps succeed, failure handling operations and their descriptions are omitted. The UE receiving Msg2 may obtain N_{TA} estimated by the base station and the uplink grant information. Additionally, N_{TA} may be updated through a MAC-CE.

In step S723, the UE may transmit a third message (i.e. message 3, Msg3) to the base station to resolve contention. At this time, Msg3 may be transmitted based on the uplink grant information. Msg3 may include a UE identifier (UE ID) and a radio resource control (RRC) setup request.

In step S723, the base station may receive Msg3 from the UE and acquire the UE ID and RRC setup request included in Msg3.

In step S724, the base station may transmit a fourth message (i.e. message 4, Msg4) to the UE in response to the reception of Msg3. Msg4 may include contention resolution-related information and a response to the RRC setup request.

In step S724, the UE may receive Msg4 from the base station. When receiving Msg4, the UE may receive Msg4 within a contention resolution window 702.

The size of the RAR window 701 described above may be configured by a parameter ra-Response Window included in an RRC message, and the size of the contention resolution window 702 may be configured by a parameter ra-ContentionResolutionTimer in an RRC message. The RRC message may include an RRC configuration message and/or an RRC reconfiguration message.

In the random access procedure, Msg1 and Msg2 may be processed at a layer 2 (L2) or below, while Msg3 and Msg4, which include the RRC setup request and its corresponding RRC response, may require processing at a layer 3 (L3), the RRC layer.

Meanwhile, in recent systems, the gNB may adopt an IAB architecture where functions are split between CU and DU. Accordingly, in NTN systems, the gNB may also be functionally split into a CU and DU. In cases where the gNB is split into a CU and DU in NTN, Msg1 and Msg2 may be processed in the DU, while Msg3 and Msg4 may be processed in the CU, which includes the RRC layer. When the NTN system adopts an architecture with functional splits between CU and DU, a delay in processing Msg1 and Msg2 and a delay in processing Msg3 and Msg4 may differ.

On the other hand, to provide NTN services to UEs unable to perform NTN communication, NTN support may be provided through a terrestrial relay supporting NTN. If a UE unable to perform NTN communication attempts to access the NTN using a terrestrial relay supporting NTN, a part of NTN-related information may need also be delivered to the UE. In such cases, the relay may transmit a part of the NTN-related information to the UE. The type of information that needs to be provided to the UE receiving NTN services through the terrestrial relay supporting NTN and methods for UE operation need to be provided. However, the 3GPP has not yet provided methods therefor.

Thus, the present disclosure describes a method and apparatus capable of addressing these issues.

The present disclosure described below relates to a system including a regenerative satellite with functional-split between CU and DU applied or a system including a relay in a mobile communication environment where an NTN is supported in 5G Advanced or 6G. Specifically, the present disclosure describes a method and apparatus for resolving timing issues caused by a delay in a non-terrestrial section when a UE accesses the NTN.

For example, the present disclosure provides a method and apparatus to address the issues of different delays during initial access to the NTN for various system architectures, such as a satellite with a transparent architecture, a satellite with a regenerative architecture, or an NTN network architecture including a relay.

Previously, FIGS. 4A to 4C have described three types of NTN architectures. Specifically, FIG. 4A has described an NTN architecture with a transparent satellite, FIG. 4B has described an NTN architecture where a full base station is included in a satellite, and FIG. 4C has described an NTN architecture where a functional-split gNB-DU is included in a satellite and a functional-split gNB-CU is included in a ground base station.

Hereafter, an additional NTN architecture including a relay node is described. A relay node may be included in the NTN according to various purposes. For example, a ground-based UE may lack a sufficient transmission power to directly transmit signals to the satellite. In such cases, the ground-based UE may transmit signals to the satellite through the relay node. Another example is a ground-based UE that does not support NTN standards. Such a UE may perform satellite communication through a terrestrial relay node supporting NTN. Other scenarios requiring relay nodes may also exist.

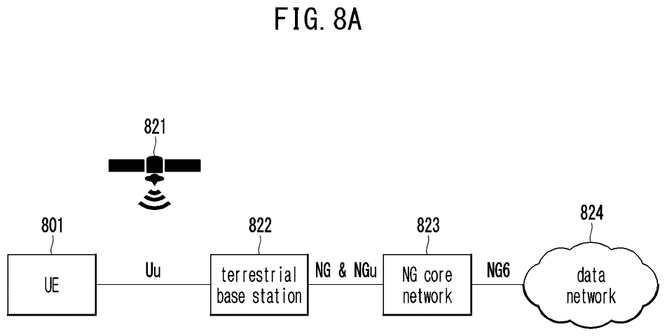

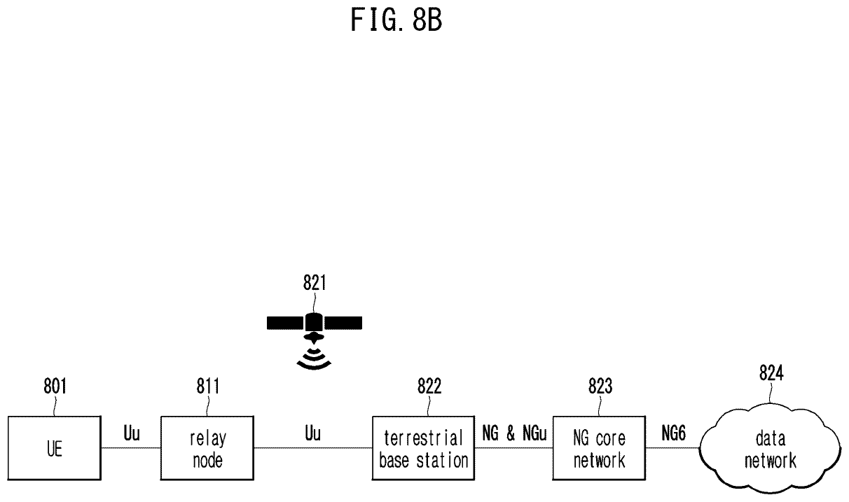

FIG. 8A is a simplified conceptual diagram illustrating an NTN architecture with a transparent satellite, and FIG. 8B is a simplified conceptual diagram illustrating an NTN architecture that includes a relay node capable of communicating with a transparent satellite.

Referring to FIG. 8A, a UE 801 may receive downlink radio frames and transmit uplink radio frames to a terrestrial base station 822 through a Uu interface via a satellite 821. In other words, the UE 801 may communicate with the ground base station 822 through the satellite 821. Here, the satellite 821 may be a transparent satellite. As described above in FIG. 4A, the transparent satellite 821 may be a node that simply amplifies and transmits signals or amplifies and performs frequency conversion before transmitting signals. The terrestrial base station 822 may transmit and receive signals (or data) to and from a data network 824 through an NG core network 823.

The configuration illustrated in FIG. 8A simplifies the architecture of the transparent satellite described earlier in FIG. 4A. Therefore, descriptions redundant with FIG. 4A are omitted.

Comparing FIG. 8B with FIG. 8A, it can be seen that FIG. 8B includes a terrestrial relay node 811 between the UE 801 and satellite 821. Here, the satellite 821 may still be a transparent satellite as in FIG. 8A.

The UE 801 may transmit and receive signals (or data) with the terrestrial relay node 811. The terrestrial relay node 811 may communicate with the terrestrial base station 822 via the satellite 821 on behalf of the UE 801. In this case, the UE 801 may either lack NTN functionality, meaning it is not able to directly communicate with satellite 821, or it may support NTN functionality but have an insufficient transmission power to deliver signals directly to the satellite 821. The UE 801 may or may not support NTN. In such cases, the UE 801 may connect to the terrestrial relay node 811 and communicate with the satellite 821 via the terrestrial relay node 811. The configuration beyond the satellite 821 may be identical to that in FIG. 8A.

Communication between the UE 801 and terrestrial relay node 811 may utilize the Uu interface. The terrestrial relay node 811 may communicate with the terrestrial base station 822 via the satellite 821 through the Un interface. Accordingly, the terrestrial relay node 811 may communicate with the satellite 821 using the Un interface, and the satellite 821 may communicate with the terrestrial base station 822 using the Un interface. The Un interface may use the NR-Uu radio interface.

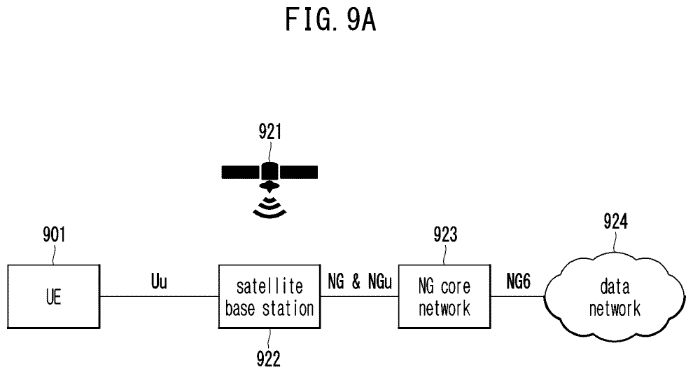

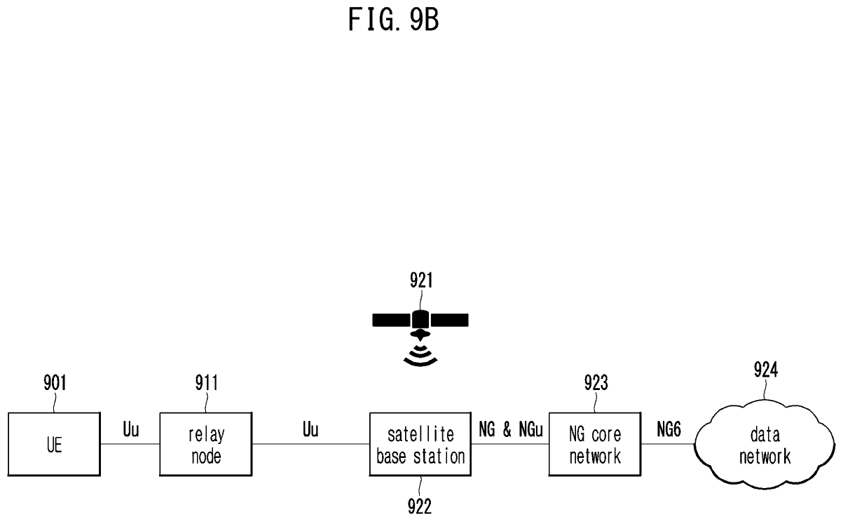

FIG. 9A is a simplified conceptual diagram illustrating an NTN architecture with a full base station-based regenerative satellite, and FIG. 9B is a simplified conceptual diagram illustrating an NTN architecture that includes a relay node capable of communicating with a base station-based regenerative satellite.

Referring to FIG. 9A, a UE 901 may receive downlink radio frames and transmit uplink radio frames through a Uu interface with a satellite base station 922. In FIG. 9A, a satellite base station 922 may be included in a satellite 921. Additionally, the satellite base station 922 may be a regenerative satellite 921 that is able to perform operations of a full base station (full gNB). Therefore, the regenerative satellite 921 may transmit and receive signals (or data) with a data network 924 through an NG core network 923. Thus, in FIG. 9A, it should be noted that the regenerative satellite 921 may refer to both the base station and the satellite.

FIG. 9A illustrates a simplified configuration of the regenerative satellite-based NG-RAN architecture described in FIG. 4B. Accordingly, it should be noted that descriptions redundant with those of FIG. 4B are omitted.

When comparing FIG. 9B with FIG. 9A, it can be seen that in FIG. 9B, a terrestrial relay node 911 is further included between the UE 901 and the regenerative satellite 921. Here, the regenerative satellite 921 may be a satellite equipped with the satellite base station 922. Additionally, the satellite base station 922 may be able to perform operations of a full base station.

The UE 901 may transmit and receive signals (or data) with the terrestrial relay node 911, and the terrestrial relay node 911 may communicate with the satellite base station 922 on behalf of the UE 901. In this case, the UE 901 may be a UE without NTN functionality, in other words, a UE that is unable to communicate with the satellite 921 or an NTN UE that is not able to directly deliver signals to the satellite 921 due to weak transmission power. The UE 901 may or may not support NTN. In such cases, the UE 901 may connect to the terrestrial relay node 911, and the UE 801 may communicate with the satellite 921 through the terrestrial relay node 911. The configuration beyond the satellite 921 may be the same as in FIG. 9A.

As illustrated in FIG. 9B, the UE 901 and the terrestrial relay node 911 may communicate using a Uu interface. The terrestrial relay node 911 may communicate with the regenerative satellite 921 using a Un interface. As previously described, the Un interface may refer to an interface between the terrestrial relay node 911 and the regenerative satellite 921 and/or satellite base station 922. The Un interface may also use an NR-Uu radio interface.

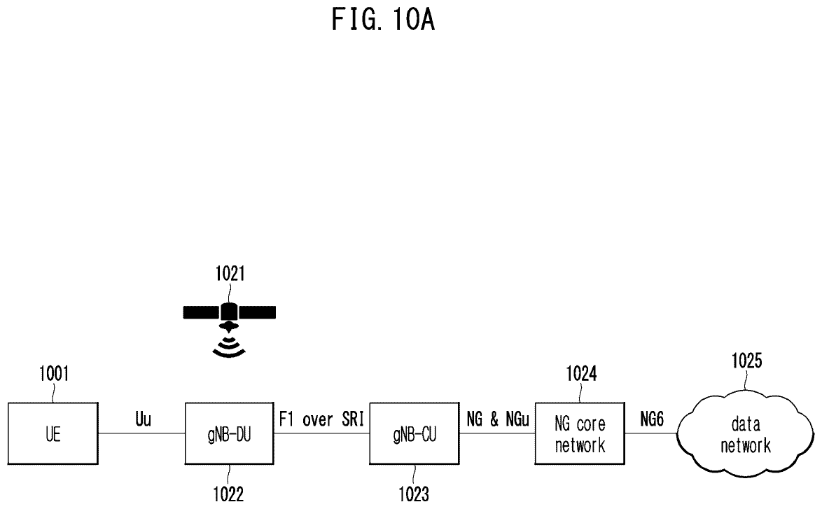

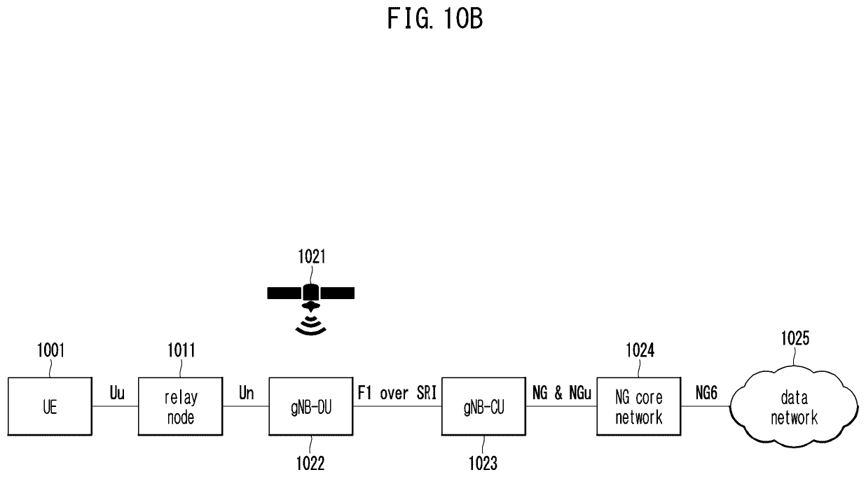

FIG. 10A is a simplified conceptual diagram illustrating an NTN architecture with a gNB-DU-based regenerative satellite, and FIG. 10B is a simplified conceptual diagram illustrating an NTN architecture that includes a relay node capable of communicating with a gNB-DU-based regenerative satellite.

Referring to FIG. 10A, a UE 1001 may receive downlink radio frames and transmit uplink radio frames through a Uu interface with a satellite 1021, which includes a gNB-DU 1022. In other words, the UE 1001 may communicate with the satellite 1021 that includes the gNB-DU 1022. Here, a base station may be split into a gNB-CU and the gNB-DU 1020 based on functional split of the base station, and the satellite 1021 may correspond to a case of including (or being equipped with) the gNB-DU 1022. The satellite that includes the gNB-DU 1022 may be referred to as a gNB-DU-based regenerative satellite.

The gNB-DU-based regenerative satellite may perform a part of operations of the base station, in other words, the operations of gNB-DU, and may communicate with a gNB-CU 1023 located on the ground. The gNB-CU 1023 may transmit and receive signals (or data) with a data network 1025 through an NG core network 1024.

FIG. 10A illustrates a simplified configuration of the NG-RAN architecture with the gNB-DU-based regenerative satellite described in FIG. 4C. Accordingly, it should be noted that descriptions redundant with those of FIG. 4C are omitted.

When comparing FIG. 10B with FIG. 10A, it can be seen that in FIG. 10B, a terrestrial relay node 1011 is further included between the UE 1001 and the satellite 1021. The UE 1001 may transmit and receive signals (or data) with the terrestrial relay node 1011, and the terrestrial relay node 1011 may communicate with the satellite 1021 on behalf of the UE 1001. Here, the satellite may be a gNB-DU-based regenerative satellite. The nodes beyond the gNB-DU-based regenerative satellite may be the same as in FIG. 10A.

As illustrated in FIG. 10B, the UE 1001 and the terrestrial relay node 1011 may communicate using a Uu interface. The terrestrial relay node 1011 may communicate with the gNB-DU-based regenerative satellite using a Un interface. As previously described, the Uu interface may refer to an interface between the terrestrial relay node 1011 and the satellite 1021 and/or gNB-DU 1022. The Un interface may also use an NR-Uu radio interface.

The architectures illustrated in FIGS. 8A, 9A, and 10A may be NTN architectures currently specified by 3GPP or considered by 3GPP. Additionally, the architectures illustrated in FIGS. 8B, 9B, and 10B may be NTN architectures in cases where a relay node exists between the satellite and UE, corresponding to those of FIGS. 8A, 9A, and 10A, respectively. When using the architectures illustrated in FIGS. 8B, 9B, and 10B, a UE that does not support NTN may connect to the terrestrial relay node using the existing NR functionality (TN functionality). Furthermore, if the terrestrial relay node supports NTN functionality, a UE that does not support NTN may utilize the NTN through the terrestrial relay node.

In the present disclosure, the relay node may be an Integrated Access and Backhaul (IAB) node or a Network Controlled Repeater (NCR) node.

Meanwhile, the current NTN specifications define only cases where NTN architectures have a transparent satellite and terrestrial base station (gNB) as illustrated in FIG. 8A. Therefore, when considering a delay in NTN, the delay may only be calculated for the architecture illustrated in FIG. 8A. In other words, when monitoring the RAR window 701 and contention resolution window 702 as described in FIG. 7, the 3GPP specifications define monitoring such windows by shifting a monitoring start time by a round trip delay (RTD) between the UE and gNB, referred to as a UE-gNB RTT. Here, the RTD may include a service link delay and a feeder link delay.

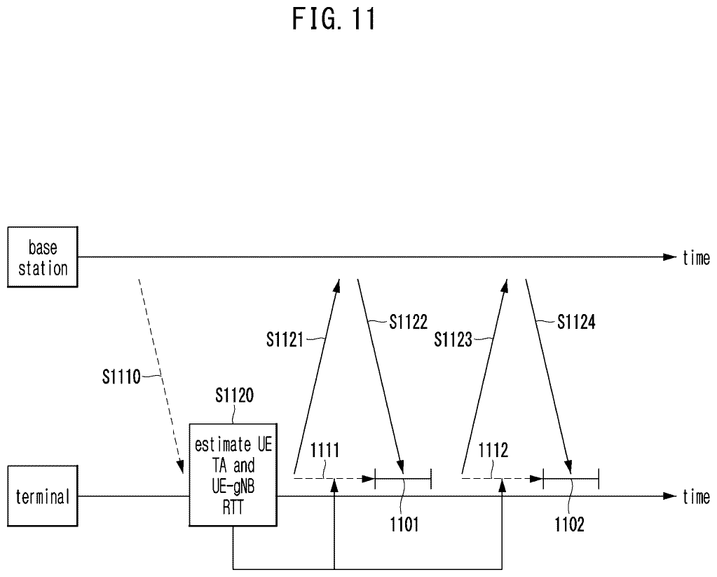

FIG. 11 is a timing diagram illustrating a random access procedure in NTN with a transparent satellite.

Referring to FIG. 11, only a UE and gNB are illustrated. In other words, a satellite is omitted in FIG. 11. This is because in FIG. 11, the satellite is a transparent satellite that performs only amplification of signals and/or frequency conversion operations. Therefore, it should be noted that the satellite is omitted in FIG. 11.

In step S1110, the base station may broadcast SSB and system information within a communication coverage of the satellite via the transparent satellite (not shown in FIG. 11). As described in FIG. 7, the SSB may include synchronization signals and/or PBCH. Additionally, the system information may include SIB1 as well as SIB19 containing NTN information and various system information. Therefore, in step S1110, the UE may receive the SSB and/or PBCH broadcasted by the base station via the satellite and acquire downlink synchronization based on the SSB. Furthermore, the UE may obtain SIB1 based on an MIB included in the PBCH in step S1110. Moreover, the UE may receive system information necessary for NTN, such as ephemeris-related information.

In step S1120, the UE may estimate a UE timing advance (TA) based on the UE's location information obtained via GNSS, information on a feeder link delay in the network, and the ephemeris-related information obtained from the system information. The UE TA may refer to a TA value estimated by the UE itself in NTN. T_{TA}, which is a transmission start time of an uplink radio frame based on the UE TA, may be calculated as described in Equation 2.

Additionally, in step S1120, the UE may calculate a UE-gNB RTT value by adding the parameter k_{mac} provided by the gNB to T_{TA}. The UE-gNB RTT value may be calculated as described in Equation 3. If k_{mac} is not provided by the gNB to the UE, the UE may assume k_{mac} to be 0.

In step S1121, the UE may transmit Msg1 to the base station via the satellite to access the network and acquire uplink synchronization. Msg1 may be configured as a preamble for random access. In this case, the UE may transmit Msg1 at a pre-compensated time corresponding to the estimated UE TA value. The estimated UE TA value may refer to an RTT between the UE and a reference point, which is estimated by the UE. Furthermore, the estimated UE-gNB RTT may refer to an RTT between the UE and the gNB. At this time, as described in FIG. 7, N_{TA} for Msg1 transmission may be set to 0. In other words, N_{TA} in Equations 2 and 3 may be set to 0.

In step S1121, the base station may receive Msg1 transmitted by the UE. In step S1121, the base station may estimate the value of N_{TA} based on Msg1 received from the UE.

In step S1122, the base station may transmit Msg2 to the UE in response to Msg1 received from the UE. Msg2 may be a random access response (RAR). Msg2 may include N_{TA} estimated by the base station. Additionally, Msg2 may include uplink grant information to permit transmission of Msg3 by the UE. The uplink grant information may be uplink resource allocation information.

In step S1122, the UE may receive Msg2 from the base station. The UE may receive Msg2 within an RAR window 1101. At this time, the UE may shift the RAR window 1101 by the UE-gNB RTT estimated by the UE itself in step S1120. FIG. 11 illustrates, using a dashed arrow 1111, that the RAR window 1101 is shifted by the UE-gNB RTT estimated by the UE itself. The UE may perform power saving during a period of the dashed arrow 1111.

If Msg2 is not received within the RAR window 1101, the UE may determine that the random access procedure has failed. Since FIG. 11 illustrates a procedure where all steps proceed successfully, handling operations for the failure and descriptions thereon are omitted. The UE receiving Msg2 may obtain N_{TA} estimated by the base station and the uplink grant information. After the random access procedure, the UE may perform RRC configuration with the base station (gNB). Subsequently, when the UE receives a MAC-CE including a TA command from the base station, the UE may update N_{TA}. It should be noted that the exemplary embodiment in FIG. 11 illustrates a case where the RAR window 1101 is shifted by the UE-gNB RTT estimated by the UE itself compared to TN.

In step S1123, the UE may transmit Msg3 to the base station to resolve contention. Msg3 may be transmitted based on the uplink grant information. Msg3 may include a UE ID for contention resolution, RRC setup request, and UE TA. Through this, the UE may notify the base station of the TA value estimated by the UE.

In step S1123, the base station may receive Msg3 from the UE and may obtain the UE ID, RRC setup request, and UE TA included in Msg3.

In step S1124, the base station may transmit Msg4 to the UE in response to reception of Msg3. Msg4 may include contention resolution-related information and may include a response to the RRC setup request.

In step S1124, the UE may receive Msg4 from the base station. The UE may receive Msg4 within a contention resolution window 1102. At this time, the contention resolution window 1102 may be shifted by the UE-gNB RTT calculated as shown in Equation 3. Here, the UE-gNB RTT may be the value estimated in step S1120 or may be an updated value if an update is performed. FIG. 11 illustrates, using a dashed arrow 1112, that the contention resolution window 1102 is shifted by the UE-gNB RTT estimated by the UE itself. The UE may perform power saving during a period of the dashed arrow 1112.

The above describes the random access procedure in the NTN with a transparent satellite. However, in future NTN, as described earlier, a full base station or a functionally-split part of the base station may be mounted on a satellite.

As described earlier in FIG. 7, Msg1 and Msg2 may be processed below L2 in the random access procedure. However, since Msg3 and Msg4 include the RRC setup request and the RRC response thereto, processing at the L3 RRC layer may be required. Additionally, if the NTN system architecture applies a functional-split IAB architecture comprising a CU and DU, Msg1 and Msg2 may be processed in the DU, and Msg3 and Msg4 may be processed in the CU, which can process the RRC layer. In such an NTN system architecture, if the IAB architecture applies a functional split between the CU and DU, delays for Msg1 and Msg2 and delays for Msg3 and Msg4 may differ. Furthermore, when a UE that does not support NTN attempts to access the NTN through a terrestrial relay node supporting NTN, the relay node may need to deliver some NTN-related information to the UE.

In the case of FIG. 9A described above, the satellite 921 may include the satellite base station 922. In other words, the satellite 921 may be equipped with the satellite base station 922. The satellite base station 922 may be a full base station. Accordingly, the satellite 921 may include all functions of the base station 922, and since L1, L2, and L3 are all included in the same satellite, the delays for Msg1 and Msg2 and the delays for Msg3 and Msg4 may be the same. In other words, since the satellite base station 922 is included in the satellite 921, L1, L2, and L3 may all be included in the satellite. Therefore, the delays for Msg1/Msg2 and the delays for Msg3/Msg4 may be the same. However, in the case of FIG. 9A, since the gNB is on the satellite 921, it may be understood that there is no feeder link delay in a delay between the UE and the gNB.

Therefore, the UE may calculate the UE TA value and the UE-gNB RTT by setting the parameter N_{TA,adj}^{common} in Equation 2 and Equation 3 to 0. Additionally, the parameter k_{mac} in Equation 3 may also be set to 0.

Based on the modified forms of Equation 2 and Equation 3 as described above, the UE may receive Msg2/Msg4 from the base station by shifting the RAR window 1101 and the contention resolution window 1102 by the UE-gNB RTT.

Furthermore, when the base station 922 is included (or mounted) in the satellite 921, a feeder link delay may not exist in a transmission delay between the UE and the gNB after random access. Moreover, the scheduling offset parameter K_{offset} described earlier may be used for data transmission. The parameter K_{offset} may be set to a value equal to or greater than a sum of the service link RTT and the common TA. However, as shown in FIG. 9A, when the base station 922 is included (or mounted) in the satellite 921, the common TA value in the calculation of the parameter K_{offset} may be set to 0. Additionally, the parameter k_{mac} may also be set to 0.

As described above, when the full base station 922 is included in the satellite 921, the method for calculating the TA value and the UE-gNB RTT or the factors required for the calculation may vary. Therefore, the base station or the network may need a method to inform the UE of the NTN architecture.

The present disclosure proposes a method in which the base station or the network informs the UE of the configuration information of the satellite constituting the NTN by transmitting regenerative indication information. The regenerative indication information may be configured in SIB19, which is system information transmitting NTN information, or in a newly defined SIBx for transmitting additional NTN information, and may be broadcast to the UE. The regenerative indication information may indicate whether the satellite is a transparent satellite or a regenerative satellite. Using the regenerative indication information, it is possible to explicitly inform the UE whether the satellite is a transparent satellite or a regenerative satellite. As another method, the network or the base station may implicitly indicate that the satellite is a regenerative satellite including the full base station by setting the parameter N_{TA,adj}^{common} included in SIB19 to 0 or a value less than 0. As yet another method, if the network or the base station does not include parameters such as TACommon, TACommonDrift, and TACommonDriftVariation, which are used to determine the parameter N_{TA,adj}^{common}, in SIB19, the parameter N_{TA,adj}^{common} may set to 0, and the network or the base station may implicitly indicate that the satellite is a regenerative satellite including the full base station.

Additionally, the regenerative indication information or additional information may be further configured as parameters for indicating the configuration of the base station included in the satellite. For example, when the additional information is included in the system information, the additional information may be an IAB-Support parameter. The IAB-Support parameter may indicate a case where only a gNB-DU is included in the satellite. When the additional information, such as the IAB-Support parameter, is not included in the system information, the UE may determine that a full base station is included in the satellite. Therefore, the inclusion or exclusion of the additional information, such as the IAB-Support parameter, in the system information may serve as an implicit scheme. As another example, the additional information, such as the IAB-Support parameter, included in the system information may be configured to indicate the configuration of the base station included in the satellite. Through this, the additional information, such as the IAB-Support parameter, included in the system information may explicitly indicate the configuration of the base station.

Next, consider the case shown in FIG. 10A where the base station has an IAB architecture, the gNB-DU 1022 is included (or mounted) in the satellite 1021, and the gNB-CU is located on the ground. As shown in FIG. 10A, in the case where the base station has an IAB architecture, the gNB-DU 1022 is included (or mounted) in the satellite 1021, and the gNB-CU is located on the ground, Msg1 and Msg2 may be processed by the gNB-DU 1022 included in the satellite 1021, and Msg3 and Msg4 may be processed by the gNB-CU 1023 on the ground. Therefore, delays for Msg1 and Msg2 and delays for Msg3 and Msg4 may differ.

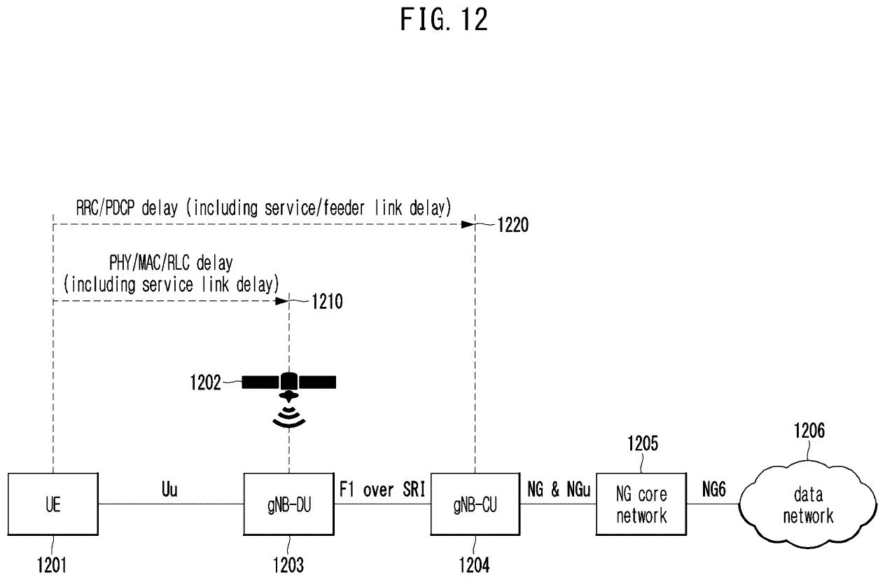

FIG. 12 is a conceptual diagram illustrating delays in an NTN where a satellite includes a gNB-DU, and a gNB-CU is located on the ground.

Referring to FIG. 12, a UE 1201 may communicate with a satellite 1202 through a Uu interface. In other words, the UE 1201 may use a Uu interface for a service link with the satellite 1202. At this time, the satellite 1202 may include (or mount) a gNB-DU 1023, as described earlier in FIG. 10A. The gNB-DU 1023 may communicate with a gNB-CU 1024 located on the ground. The gNB-CU 1024 may communicate with a data network 1026 through an NG core network 1205. Since this configuration has been described in FIG. 10A as well as FIG. 4C, redundant descriptions are omitted.

In the NTN with the configuration shown in FIG. 12, a processing delay 1210 between the UE 1201 and a PHY layer/MAC layer/RLC layer of the gNB-DU 1203 may include an RTD of the service link. Additionally, in the NTN with the configuration shown in FIG. 12, a processing delay 1220 between the UE 1201 and an RRC layer/PDCP layer of the gNB-CU 1204 may include both the RTD of the service link and an RTD of a feeder link. In other words, processing delays for Msg1 and Msg2 and processing delays for Msg3 and Msg4 in a random access procedure may differ. Therefore, a shift value for the RAR window 1101 and a shift value for the contention resolution window 1102, as described earlier in FIG. 11, may need to use different values.

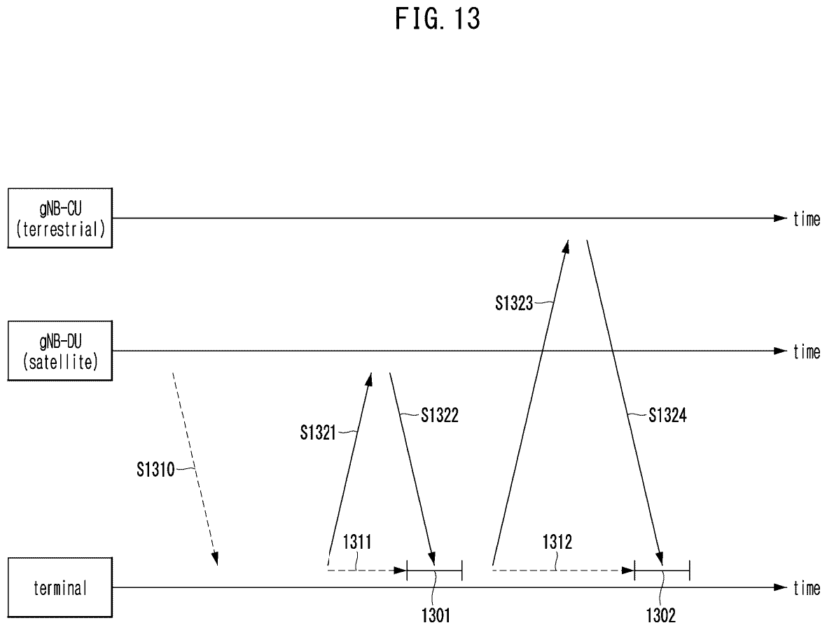

FIG. 13 is a timing diagram illustrating a random access procedure in an NTN with an IAB architecture where a satellite includes a gNB-DU, and a gNB-CU is located on the ground.

Referring to FIG. 13, the NTN may have an IAB architecture where a satellite includes a gNB-DU, and a gNB-CU is located on the ground, the configuration may be the same as that in FIG. 12. In such a case, as described in FIG. 12, the gNB-DU may perform processing for the PHY layer/MAC layer/RLC layer, and the gNB-CU may perform processing for the RRC layer/PDCP layer.

In step S1310, the base station may broadcast synchronization signals, system information, and the like within its communication coverage, for example, a communication coverage where satellite signals can reach. More specifically, the synchronization signals and system information may be broadcast by the gNB-DU included in the satellite. The synchronization signals may correspond to SSB and/or PBCH, as described earlier. Additionally, the system information may refer to various system information such as SIB1, SIB19, and SIBx. SIB19 may include information for accessing a satellite network in 5G NR.

In step S1310, the UE may receive the SSB and/or PBCH broadcast by the base station and acquire downlink synchronization based on the SSB and PBCH. Furthermore, in step S1310, the UE may obtain SIB1 based on an MIB included in the PBCH. The UE may obtain scheduling information of SIB19 based on the information included in SIB1. Therefore, the UE may obtain SIB19 based on SIB1. The UE may estimate N_{TA,adj}^{common} and N_{TA,adj}^{UE} using the location information of the UE obtained via GNSS, and feeder link delay and ephemeris-related information obtained from the system information such as SIB19 received from the gNB-DU.

In step S1321, the UE may transmit Msg1 of a random access procedure to the gNB-DU. Msg1 may be configured as a preamble for random access. At this time, when the UE transmits Msg1 configured as the preamble, the UE may pre-compensate a transmission time of Msg1 using the estimated N_{TA,adj}^{common} and the estimated N_{TA,adj}^{UE}. In other words, the UE may calculate the UE TA value based on the estimated N_{TA,adj}^{common} and N_{TA,adj}^{UE}. The UE TA value may refer to the TA value estimated by the UE itself, as described earlier. The transmission time of Msg1 may be pre-compensated based on the UE TA value. At this time, since Msg1 is transmitted to the gNB-DU, it does not experience a feeder link to the gNB-CU. Therefore, when the UE can know the architecture of the NTN in advance, N_{TA,adj}^{common} may be set to 0. If the UE can know the architecture of the NTN in advance, the regenerative indication information and/or additional information that may be included in SIB19 or SIBx, as described in FIG. 11, may be used. Alternatively, if the UE cannot know the architecture of the NTN in advance, when the gNB does not include parameters related to N_{TA,adj}^{common} in the system information, the UE may set N_{TA,adj}^{common} to 0. In other words, if the network or the base station does not include parameters such as TACommon, TACommonDrift, and TACommonDriftVariation, which are used to determine N_{TA,adj}^{common}, in SIB19, N_{TA,adj}^{common} may be set to zero (0), implicitly indicating that the satellite is a regenerative satellite.

When transmitting Msg1, the UE may apply T_{TA} calculated by setting N_{TA,adj}^{common} to 0 in Equation 2 as the UE TA value. Additionally, the UE may apply the UE TA value by setting N_{TA} in Equation 2 to 0 when transmitting Msg1.

In step S1321, the gNB-DU may receive Msg1 transmitted by the UE. In step S1321, the base station may estimate N_{TA} using Msg1 received from the UE.

In step S1322, the base station may transmit Msg2 to the UE in response to Msg1 received from the UE. Msg2 may be an RAR. Msg2 may include N_{TA} estimated by the base station and may include uplink grant information for the UE to transmit Msg3. The uplink grant information may be uplink resource allocation information. Additionally, the base station may later update N_{TA} by transmitting N_{TA} estimated by the base station to the UE through a MAC-CE.

In step S1322, the UE may receive Msg2 from the base station. The UE may receive Msg2 within an RAR window 1301. At this time, the RAR window 1301 may be shifted by an RTT between the UE and the gNB-DU. The RTT between the UE and the gNB-DU in the NTN may be calculated as described earlier in Equation 3. Since the RTT between the UE and the gNB-DU does not include a feeder link delay, N_{TA,adj}^{common} in Equation 3 may be set to 0. Additionally, k_{mac} may also be set to 0. Moreover, when transmitting and receiving Msg1 and Msg2, N_{TA} may be set to 0. Therefore, the RAR window 1301 may be shifted by an RAR window shift time 1311. The RAR window shift time 1311 may be calculated based on the RTT between the UE and the gNB-DU, as described above. More specifically, since Msg1 is transmitted to the gNB-DU, there is no feeder link delay. Accordingly, the RTT between the UE and the gNB-DU, in other words, the RAR window shift time 1311, may be calculated as shown in Equation 4 below.

$$RTT between UE and gNB - DU = {T}_{TA} + {k}_{mac} = ( {N}_{TA} + {N}_{TA , offset} + {N}_{TA , adj}^{c o mmon} + {N}_{TA , adj}^{UE} ) \times {T}_{c} + {k}_{mac} = ( {N}_{TA} + {N}_{TA , offset} + 0 + {N}_{TA , adj}^{UE} ) \times {T}_{c} + {k}_{mac} = ( 0 + {N}_{TA , offset} + 0 + {N}_{TA , adj}^{UE} ) \times {T}_{c} + 0 \qquad [ Equation 4 ]$$

If Msg2 is not received within the RAR window 1301, the UE may determine that the random access procedure has failed. Since the exemplary embodiment of FIG. 13 illustrates a procedure where all steps are successfully performed, failure handling operations and descriptions thereon are omitted. The UE receiving Msg2 may obtain N_{TA} estimated by the base station and uplink grant information. Furthermore, N_{TA} may be updated through a MAC-CE.

In step S1323, the UE may transmit Msg3, which includes an RRC setup request, to the base station. At this time, Msg3 may be transmitted based on the uplink grant information. Msg3 may include a UE ID for contention resolution and the RRC setup request.

In step S1323, the base station may receive Msg3 from the UE and may obtain the UE ID and the RRC setup request included in Msg3.

In step S1324, the base station may transmit Msg4 to the UE in response to the reception of Msg3. Msg4 may include contention resolution-related information and a response to the RRC setup request.

In step S1324, the UE may receive Msg4 from the base station. At this time, the UE may receive Msg4 within a contention resolution window 1302.

In this case, the contention resolution window 1302 may be shifted by a shift value calculated based on the RTT between the UE and the gNB-CU. The RTT between the UE and the gNB-CU in the NTN may be calculated as described earlier in Equation 3. Since the RTT between the UE and the ground-based gNB-CU includes a feeder link delay, it includes the RTT between the satellite and the reference point and the RTT between the reference point and the gNB-CU. Therefore, the contention resolution window 1302 may be shifted by a contention resolution window shift time 1312.

The contention resolution window shift time 1312 may be calculated based on the RTT between the UE and the gNB-CU, as described above. At this time, since the UE has received N_{TA} from the base station in Msg2, the UE may use N_{TA} received from the base station. More specifically, since Msg3 is transmitted to the gNB-CU, a feeder link delay may occur. Accordingly, the RTT between the UE and the gNB-CU, in other words, the contention resolution window shift time 1312, may be calculated as shown in Equation 5 below:

$$RTT between UE and gNB - CU = {k}_{mac} + {T}_{TA} = {k}_{mac} + ( {N}_{TA} + {N}_{TA , offset} + {N}_{TA , adj}^{common} + {N}_{TA , adj}^{UE} ) \times {T}_{c} \qquad [ Equation 5 ]$$

As described earlier, the parameter k_{mac} may be set to the same value as the RTT between the reference point 604 and the gNB, and this value is a value notified by the network or the satellite gNB-DU through system information. In the NTN architecture with an IAB architecture where the satellite includes a gNB-DU and a gNB-CU is located on the ground, the parameter k_{mac} may be used to calculate the RTT between the UE and the gNB-CU, as shown in Equation 5. Since L1 and L2 processing is performed in the satellite's gNB-DU, a feeder link delay is not included in L1 and L2 processing. The parameter k_{mac} may not be used for delaying an application time of a configuration indicated by a MAC CE command received through a PDSCH.

The size of the RAR window 1301 described above may be configured by a parameter ra-Response Window included in an RRC message, and the size of the contention resolution window 1302 may be configured by a parameter ra-ContentionResolutionTimer in the RRC message. Here, the RRC message may include either an RRC configuration message and/or an RRC reconfiguration message.

Meanwhile, the value of K_{offset} used for data transmission may be set to a value equal to or greater than a sum of the service link RTT and the value of the common TA, N_{TA,adj}^{common}. In the architecture of a regenerative satellite that includes a gNB-DU, since L1 processing is performed in the satellite's gNB-DU, the common TA may be set to 0 in calculating the value of K_{offset}.

Meanwhile, to notify the NTN architecture described above, the gNB may further include additional information in SIB19 or SIBx that indicates the regenerative indication information and/or the IAB-Support parameter. Therefore, the UE may identify the NTN architecture in advance by using the regenerative indication information and/or additional information from the system information.

In the present disclosure described above, the UE may have NTN communication capability. In other words, the satellite of the NTN may have one of the following three configurations.
1) A satellite with a transparent architecture
2) A regenerative satellite including a full base station
3) A regenerative satellite including a gNB-DU

Hereinafter, a case will be described in which the UE does not have NTN communication capability. In this case, communication with the NTN is conducted using a relay node, as described in FIG. 8B, FIG. 9B, and FIG. 10B.

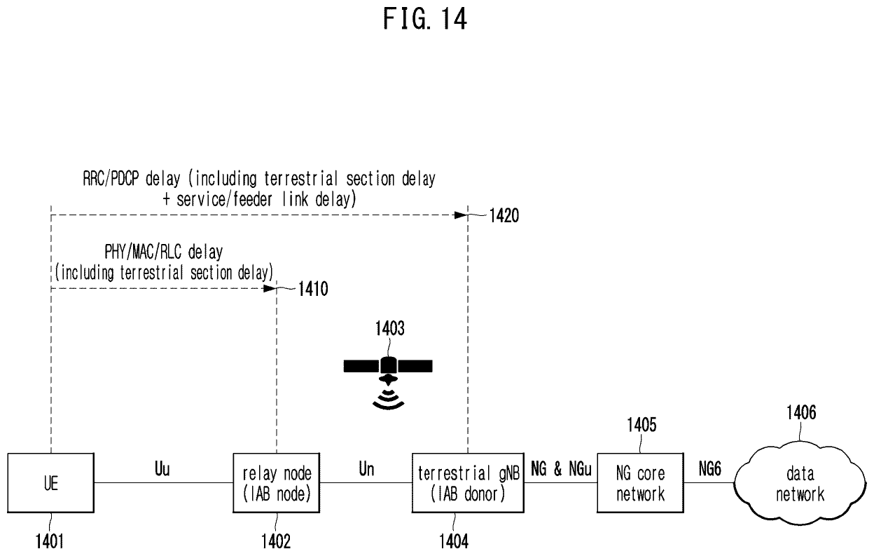

FIG. 14 is a conceptual diagram illustrating a delay in a case where a UE communicates with an NTN having a transparent satellite via a relay node.

Referring to FIG. 14, a UE 1401, a relay node 1402, a transparent satellite 1403, a terrestrial gNB 1404, an NG core network 1405, and a data network 1406 are illustrated. The architecture illustrated in FIG. 14 may have the same configuration as the architecture described earlier in FIG. 8B. A difference between FIG. 14 and FIG. 8B described earlier is that the terrestrial relay node 1402 is an IAB node configured as a DU, while the terrestrial base station 1404 is configured as an IAB donor including a CU. Therefore, FIG. 14 may be a specific example of FIG. 8B.

Since the terrestrial relay node 1402 functions as an IAB node performing functions of a DU, a delay 1410 between the UE 1401 and the relay node 1402 may be a delay of a PHY layer/MAC layer/RLC layer, as described in the IAB architecture. In other words, the delay 1410 between the UE 1401 and the relay node 1402 may be an RTD of the PHY layer/MAC layer/RLC layer. Since the delay 1410 is a delay in a terrestrial section, it may be understood identically as a delay in TN.

Additionally, a delay 1420 between the UE 1401 and the terrestrial gNB 1404 may include a terrestrial section delay along with a service link delay and a feeder link delay. Since the terrestrial gNB 1404 performs a role of a CU for the UE 1401 in the IAB architecture, only messages (or signals or data) of the RRC layer/PDCP layer may be transmitted between the terrestrial gNB 1404 and the UE 1401. Therefore, the delay 1420 between the UE 1401 and the terrestrial gNB 1404 may occur when signals (or messages) of the RRC layer and PDCP layer are transmitted and received. In other words, the delay 1420 between the UE 1401 and the terrestrial gNB 1404 may be an RTD of the RRC layer/PDCP layer.

In the configuration illustrated in FIG. 14, it can be seen that processing delays for Msg1 and Msg2 differ from those for Msg3 and Msg4 in the random access procedure. Therefore, it can be concluded that different values may need to be used for shifting of the RAR window and shifting of the contention resolution window.

Although not illustrated in FIG. 14, the relay node 1402 may be divided into an IAB Mobile Termination (MT) and an IAB DU. The IAB DU of the relay node 1402 may have a function to communicate with the UE 1401 but does not have NTN functionality. On the other hand, the IAB MT of the relay node 1402 may have NTN functionality to connect to the satellite.

Additionally, the UE 1401 illustrated in FIG. 14 may not have NTN functionality, as described above. The relay node 1402 may perform operations corresponding to the DU of the terrestrial gNB 1404. Therefore, when the UE 1401 transmits and receives data of the PHY layer/MAC layer/RLC layer with the relay node 1402, the UE 1401 may communicate in the same manner as when connecting to the TN, even without NTN functionality.

However, since the processing of Msg3 and Msg4 in the random access procedure requires data processing of the RRC layer/PDCP layer, the UE may need to be able to recognize information on an NTN delay, which is different from a TN delay. In other words, Msg1 and Msg2 are transmitted in the terrestrial section during the random access procedure, so even a non-NTN UE can process them without issues. However, since Msg3 and Msg4 are processed in the RRC layer and traverse the service link and feeder link, the UE may need to recognize information on the delays for Msg3 and Msg4 to reliably transmit and receive Msg3 and Msg4. Therefore, the terrestrial base station 1404 and/or the relay node 1402 may need to provide information on the NTN delay to the UE 1401.

The terrestrial relay node 1402 may provide information on the delay of the RRC layer/PDCP layer to the UE 1401. When the UE receives information on the delay of the RRC layer/PDCP layer, the UE may need to apply the corresponding delay when transmitting messages (or data) of the RRC layer/PDCP layer. Through this process, even the UE 1401 that does not support NTN may connect to the NTN through the relay node 1402 if the UE can process such delay-related information.

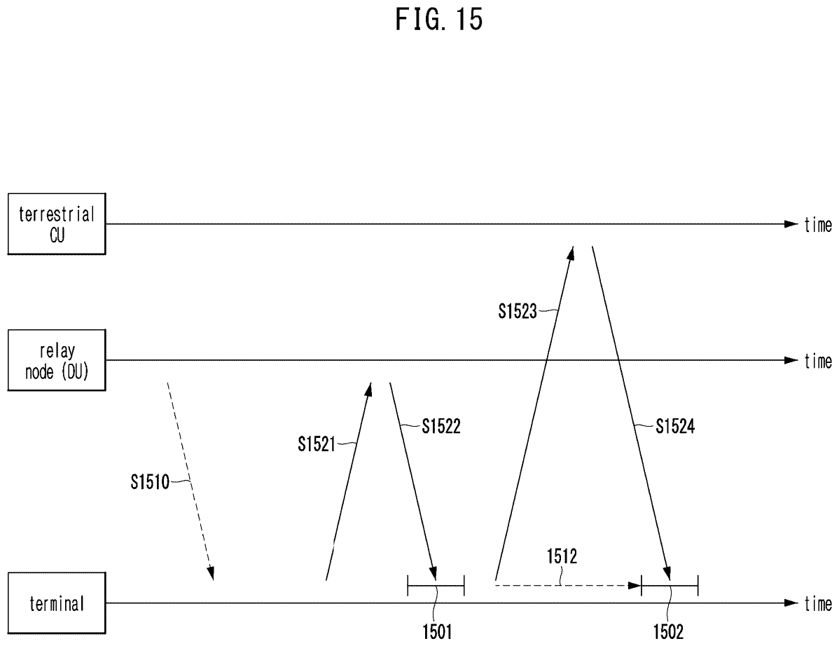

FIG. 15 is a timing diagram illustrating a random access procedure performed by a UE to a base station via a relay node in an NTN with a transparent satellite.

The timing diagram according to the example of FIG. 15 may correspond to an example of a random access procedure based on the configuration described in FIG. 14. Accordingly, the relay node may perform functions of a DU as described in FIG. 14, and the terrestrial CU may correspond to the terrestrial gNB illustrated in FIG. 14. Therefore, there may be a transparent satellite between the relay node and the terrestrial CU.

In step S1510, the relay node may broadcast synchronization signals, system information, and the like within a communication coverage. The synchronization signals may correspond to SSB and/or PBCH, and the system information may refer to various system information, such as SIB1 and SIBx. In the present disclosure, SIBx may be a newly defined SIB for NTN relay nodes or an extended SIB that includes information for NTN relay nodes in an existing SIB. SIBx may include information on a delay between the terrestrial CU and the terrestrial relay node (DU). In other words, SIBx may include information on delays of a service link and a feeder link between the relay node and the terrestrial CU. An RTT between the relay node and the terrestrial CU may be calculated as shown in Equation 6.

$$RTT between relay node and terrestrial CU = {k}_{mac} + ( {N}_{TA} + {N}_{TA , offset} + {N}_{TA , adj}^{c o mmon} + {N}_{TA , adj}^{UE} ) \times {T}_{c} \qquad [ Equation 6 ]$$

In Equation 6, each parameter may correspond to the parameter between the IAB-MT of the relay node (DU) configured to support UE functionality and the terrestrial CU in the NTN. Since the terrestrial relay node (DU) has NTN UE functionality, the terrestrial relay node may calculate Equation 6 in the same manner as the UE in an NTN with a transparent satellite. Additionally, the IAB-DU of the relay node (DU) may include a value calculated as in Equation 6 in SIBx and transmit SIBx to a UE that does not support NTN functionality.

As described earlier, the parameter k_{mac} in Equation 6 is set to the same value as the RTT between the reference point on the feeder link and the terrestrial gNB and is notified by the network or the terrestrial relay node through system information. In the NTN architecture where the UE communicates with an NTN having a transparent satellite through a relay node, the parameter k_{mac} may be used to calculate the RTT between the terrestrial relay node and the terrestrial gNB (CU), as shown in Equation 6. Since L1 and L2 processing is performed in the terrestrial relay node, the delays of L1 and L2 processing includes only the same delays as in the existing TN. Therefore, the parameter k_{mac} may not be used for delaying an application time of a configuration indicated by a MAC CE command received through a PDSCH. Additionally, SIBx may further include information on a type of the relay node. The relay node type information may indicate whether the terrestrial relay node supports NTN access and whether the satellite connected to the relay node is a transparent satellite or a regenerative satellite.

Instead of explicitly indicating the relay node type information as described above, an implicit scheme may also be used. For example, if the RTT between the relay node and the terrestrial CU included in SIBx is not 0, it may implicitly indicate that the relay node is an NTN relay.

In step S1510, the UE may receive synchronization signals, system information, and the like from the relay node. The UE may acquire downlink synchronization with the relay node based on the received synchronization signals and identify the relay node type information from the received system information. If the UE is not able to decode the received SIBx, the UE may not be able to connect to the relay node for NTN access.

As another method to restrict UE access, the relay node may restrict UE access using a cell barring indication in SIB1. Through this, the relay node may block a UE that cannot connect to the NTN, in other words, a UE that cannot perform different timing adjustments as required by the present disclosure, thereby preventing unnecessary RACH procedures.

In step S1521, the UE may transmit Msg1 to the relay node. At this time, the UE may be a UE that has obtained the RTT between the relay node and the terrestrial CU through SIBx included in the system information received from the relay node. In other words, the UE may be a UE that has decoded SIBx or is not subject to cell barring. Additionally, when transmitting Msg1, the UE may determine T_{TA} using Equation 1, as in the existing TN, and may set N_{TA} to 0 when transmitting Msg1.

In step S1521, the relay node may receive Msg1. Msg1 received by the relay node in step S1521 may have been transmitted by the UE without any compensation. Therefore, the relay node receiving Msg1 transmitted by the UE may estimate N_{TA} based on the received Msg1.

In step S1522, the relay node may transmit Msg2 to the UE in response to Msg1 received from the UE. Msg2 may be an RAR. Msg2 may include N_{TA} estimated by the base station and may include uplink grant information. The uplink grant information may be uplink resource allocation information.

In step S1522, the UE may receive Msg2 from the relay node. The UE may receive Msg2 within an RAR window 1501. At this time, as illustrated in FIG. 15, the RAR window 1501 may be in a state without a shift. Since the relay node is located on the ground, the UE may receive Msg2 within the RAR window 1501 from the terrestrial relay node in the same manner as in the TN. Therefore, shifting of the RAR window may not be necessary. The UE receiving Msg2 may obtain N_{TA} estimated by the relay node and uplink grant information. Furthermore, N_{TA} may be updated through a MAC-CE.

In step S1523, the UE may transmit Msg3 to the relay node to resolve contention. At this time, Msg3 may be transmitted based on the uplink grant information. Msg3 may include a UE ID and an RRC setup request. Additionally, as illustrated in FIG. 15, Msg3 may be transmitted to the terrestrial CU via the transparent satellite using the IAB-MT of the relay node.

In step S1523, the terrestrial CU may receive Msg3 transmitted by the UE via the IAB-MT of the relay node and the transparent satellite and may obtain the UE ID and the RRC setup request included in Msg3.

In step S1524, the terrestrial CU may transmit Msg4 to the UE via the transparent satellite and the relay node.

In step S1524, the UE may receive Msg4 transmitted by the terrestrial CU via the relay node. At this time, the contention resolution window 1502 for receiving Msg4 may be shifted by the RTT 1512 between the relay node and the terrestrial CU obtained through SIBx.

In the configuration illustrated in FIGS. 14 and 15, the RTT 1512 between the relay node and the terrestrial CU may be applied to transmission of messages (or data) of the RRC layer and/or the PDCP layer, but the transmission of data below Layer 2 (L2) may be performed in the same manner as in the TN. In other words, values such as K_{offset} and k_{mac}, are not applied to communication between the UE and the terrestrial relay node. In this architecture, the value k_{mac} may be set to the same value as the RTT between the reference point on the feeder link and the terrestrial gNB, as described earlier, and may be used to calculate the RTT between the terrestrial relay node and the terrestrial gNB (CU), as shown in Equation 6. The parameter k_{mac} may not be used for delaying an application time of a configuration indicated by a MAC-CE command received through a PDSCH.

A UE communicating in a network like that illustrated in FIGS. 14 and 15 may need to extend timers or windows in the RRC layer and/or the PDCP protocol by the RTT between the relay node and the terrestrial CU. Therefore, if the RTT between the relay node and the terrestrial CU changes after initial access, the updated RTT value between the relay node and the terrestrial CU may need to be provided to the UE. The updated value may be provided to the UE from the relay node through an extended MAC-CE or a newly defined MAC-CE according to the present disclosure.

The extended MAC-CE may correspond to a case where a MAC-CE field is extended (or redefined) to include the updated RTT value when the RTT between the relay node and the terrestrial CU changes. The newly defined MAC-CE may include a field for delivering the new RTT value along with a command instructing the update of the RTT value when the RTT between the relay node and the terrestrial CU changes. Through this method, the updated RTT value between the relay node and the terrestrial CU can be delivered to the UE.

As described above, the NTN relay node may provide the RTT between the relay node and the terrestrial CU to a non-NTN UE without NTN functionality, allowing the non-NTN UE to easily utilize the NTN environment.

If an NTN UE uses the NTN through a relay node, the NTN UE can communicate through the NTN in the same manner as the non-NTN UE described above if the NTN UE can decode SIBx. To enable the NTN UE to communicate via the relay node, the terrestrial relay node may broadcast SIB19, which includes satellite-related information. Accordingly, the NTN UE may receive SIB19 from the relay node, calculate the delay based on the delay-related parameters, and operate as described above by performing the calculation in the same manner as described earlier.

Next, delays of a non-NTN UE will be described for a case where the NTN is configured as described in FIG. 10B and includes a relay node.

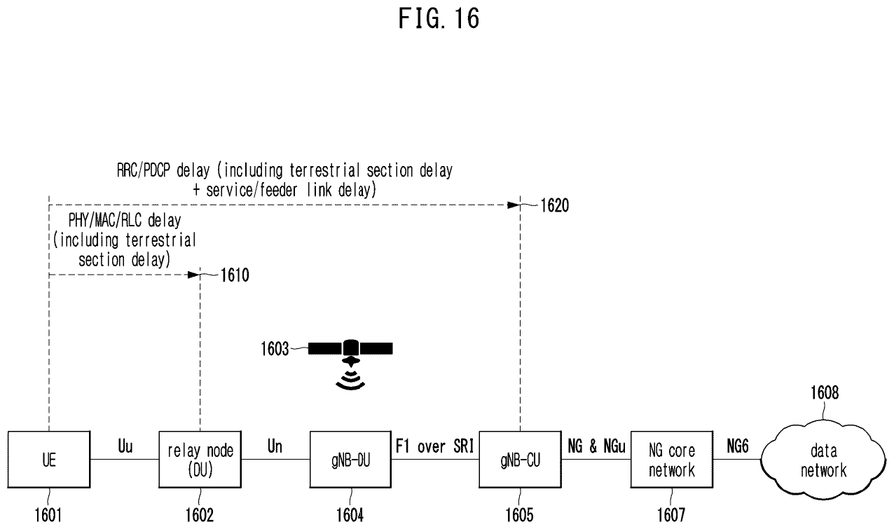

FIG. 16 is a conceptual diagram illustrating delays when a UE communicates with an NTN via a relay node in a case where the NTN comprises a regenerative satellite including a gNB-DU and a terrestrial gNB-CU.

Referring to FIG. 16, a UE 1601 without NTN functionality, a relay node 1602, a satellite 1603 including a gNB-DU 1604, a terrestrial gNB-CU 1605, an NG core network 1606, and a data network 1607 are illustrated. The architecture illustrated in FIG. 16 may correspond to the configuration described in FIG. 10B. A difference between FIG. 16 and the previously described FIG. 10B is that the relay node 1602 is configured as an IAB node including a DU. Additionally, the terrestrial gNB-CU 1605 may function as an IAB donor. Accordingly, the terrestrial relay node 1602 and the satellite's gNB-DU 1604 may form a hierarchical architecture between DUs in the IAB. In other words, the architecture may represent a multi-hop relay architecture between DUs.

The example of FIG. 16, compared to FIGS. 14 and 15 described earlier, may be understood as being similar except that the satellite 1603, which includes the gNB-DU, is additionally included between the relay node and the terrestrial gNB-CU.

Since the relay node 1602 functions as an IAB node and performs a role of a DU, a delay 1610 between the UE 1601 and the relay node 1602 may correspond to a delay in the PHY layer/MAC layer/RLC layer, as described in the IAB architecture. In other words, the delay 1610 between the UE 1601 and the relay node 1602 may be an RTD of the PHY layer/MAC layer/RLC layer. As this is a delay in the terrestrial section, it may be understood as equivalent to a delay in TN.

On the other hand, a processing delay 1620 of the RRC layer/PDCP layer may include the TN RTD (the delay between the UE 1601 and the relay node 1602), a service link RTD between the terrestrial IAB node, which is the relay node 1602, and the satellite 1603/gNB-DU 1604, and a feeder link RTD between the satellite 1603/gNB-DU 1604 and the terrestrial gNB-CU 1605.

Thus, in the case of FIG. 16, processing delays for Msg1 and Msg2 and processing delays for Msg3 and Msg4 in a random access procedure differ. In this case, shifting of an RAR window may not be used, and only shifting of a contention resolution window may need to be used. In other words, different shift values for the RAR window and the contention resolution window may need to be set.

The relay node 1602 illustrated in FIG. 16 may be divided into an IAB MT and an IAB DU. The IAB DU of the relay node 1602 may have functionality to communicate with the UE 1601 and may not have NTN functionality. On the other hand, the IAB MT of the relay node 1602 may have NTN functionality to access the satellite.

When the UE 1601 transmits and receives data of the PHY layer/MAC layer/RLC layer with the relay node 1602, the UE 1601 may communicate in the same manner as when accessing the TN without requiring NTN functionality.

However, for processing Msg3 and Msg4 in the random access procedure, data processing in the RRC layer/PDCP layer is required. Therefore, the UE 1601 may need to know information on an NTN delay, which differs from the TN delay, to process Msg3 and Msg4 properly.

In other words, since Msg1 and Msg2 in the random access procedure are transmitted in the terrestrial section, the non-NTN UE may process these messages without issues. However, as Msg3 and Msg4, processed in the RRC layer, pass through the service link and feeder link, the UE 1601 may need to know information on delays for the service link and feeder link to transmit and receive Msg3 and Msg4 properly. Therefore, the terrestrial base station 1605 and/or the relay node 1602 may need to provide information on the NTN delays to the UE 1601.

The terrestrial relay node 1602 may need to inform the UE 1601 of information on the delay of the RRC layer/PDCP layer, so that the UE 1601 applies the delay when transmitting messages (or data) of the RRC layer/PDCP layer. By processing only information that indicates different delays per layer, the UE 1601 that does not support NTN functionality may be able to access the NTN via the relay node 1602.

In the case of FIG. 16, unlike the case with the transparent satellite described in FIGS. 14 and 15, the satellite 1603 includes the gNB-DU 1604, which may result in an additional hop being added to the delay between the relay node 1602 and the gNB-CU 1605. Therefore, the terrestrial gNB-CU 1605 may need to provide a delay value between the satellite gNB-DU 1604 and the terrestrial gNB-CU 1605 to the terrestrial relay node 1602 through an F1 interface or similar means. The relay node 1602 may need to provide, to the UE 1601, information on the delay between the relay node 1602 and the gNB-CU 1605. This delay is determined by reflecting two components: the delay between the gNB-DU 1604 and the gNB-CU 1605, which is received from the terrestrial gNB-CU 1605, and the delay between the relay node 1602 and the satellite gNB-DU, which is calculated by the relay node 1602.

Another method of providing information on the delay between the relay node 1602 and the gNB-CU 1605 to the UE 1601 may be a method of determining the delay between the relay node 1602 and the gNB-CU 1605 using the NTN UE functionality of the IAB-MT of the relay node 1602. In other words, the relay node 1602 may receive various system information, such as SSB, SIB1, SIB19, and SIBx broadcasted by the satellite gNB-DU 1604, using the IAB-MT. Based thereon, the relay node 1602 may calculate the parameters N_{TA,adj}^{common} and N_{TA,adj}^{UE} for itself using information related to a feeder link delay between the satellite gNB-DU 1604 and the gNB-CU 1605, ephemeris information, and location information of the relay node 1602 obtained via GNSS. The relay node 1602 may receive N_{TA} and N_{TA,offset} for itself from the satellite gNB-DU 1604. Additionally, the relay node 1602 may obtain k_{mac} through the system information. Using the parameters described above, along with the calculated or obtained information, the relay node 1602 may obtain information on the delay between the relay node 1602 and the gNB-CU 1605 through Equation 3. The relay node 1602 may provide information on the delay between the relay node 1602 and the gNB-CU 1605 to the UE through system information.

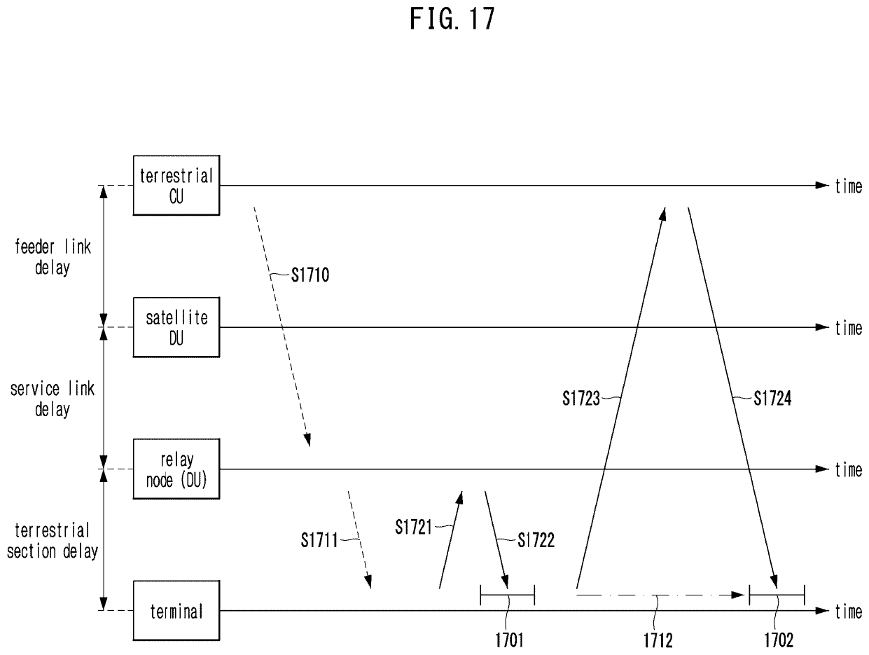

FIG. 17 is a timing diagram illustrating a random access procedure for an NTN having a satellite DU and a terrestrial CU via a relay node.

The timing diagram in FIG. 17 may correspond to an example of a random access procedure for the configuration described in FIG. 15. Therefore, the relay node may perform the DU function as described in FIG. 15, and the terrestrial CU may correspond to the terrestrial CU illustrated in FIG. 15. Thus, a satellite equipped with a gNB-DU may be present between the relay node and the terrestrial CU.

In step S1710, the terrestrial CU may deliver information on the delay between the terrestrial CU and the satellite DU to the terrestrial relay via the satellite DU using an F1 interface. Here, the delay between the terrestrial CU and the satellite DU may correspond to a feeder link delay. An RTT between the terrestrial CU and the satellite DU may be calculated as shown in Equation 7 below.

$$RTT between satellite DU and terrestrial CU = {k}_{mac} + ( {N}_{TA , adj}^{common} ) \times {T}_{c} \qquad [ Equation 7 ]$$

In Equation 7, each parameter may be a parameter between the terrestrial CU and the satellite DU. Thus, compared to Equation 6 described earlier, it can be seen that the parameter N_{TA,adj}^{UE} does not exist because there is no service link.

In step S1710, the terrestrial relay may receive information (or value) on the RTT between the terrestrial CU and the satellite DU such as that shown in Equation 7, from the terrestrial CU via the satellite DU. Since the terrestrial relay has NTN UE functionality, the MT of the terrestrial relay DU may calculate a delay value for a service link with the connected satellite DU. In other words, the terrestrial relay may calculate the RTT between the terrestrial relay and the satellite DU. The RTT between the terrestrial relay and the satellite DU may be calculated as shown in Equation 8 below.

$$RTT between terrestrial relay and satellite DU = ( {N}_{TA} + {N}_{TA , offset} + {N}_{TA , adj}^{UE} ) \times {T}_{c} \qquad [ Equation 8 ]$$

In Equation 8, each parameter may be a parameter between the terrestrial relay and the satellite DU. Since there is no feeder link between the terrestrial relay and the satellite DU, it can be seen that the parameters N_{TA,adj}^{common} and k_{mac} do not exist.

The terrestrial relay may determine the RTT between the terrestrial relay and the terrestrial CU as a sum of the RTT between the terrestrial relay and the satellite DU, calculated using Equation 8, and the RTT between the terrestrial CU and the satellite DU, received through the F1 interface, as shown in Equation 7. It can be seen that the sum of Equation 7 and Equation 8 is equivalent to Equation 3.

Another method for determining the delay between the relay node 1602 and the gNB-CU 1605 is to use the NTN UE functionality of the IAB-MT of the relay node 1602, as described above, to determine the delay between the relay node 1602 and the gNB-CU 1605. In other words, the relay node 1602 is able to receive various system information, such as SSB, SIB1, SIB19, and SIBx, broadcast by the satellite gNB-DU 1604 using the IAB-MT. Based thereon, the relay node 1602 may calculate the parameters N_{TA,adj}^{common} and N_{TA,adj}^{UE} for itself using information related to a feeder link delay between the satellite gNB-DU 1604 and the gNB-CU 1605, ephemeris information, and location information of the relay node obtained via GNSS. The IAB-MT of the relay node 1602 may receive N_{TA} and N_{TA,offset} for itself from the satellite gNB-DU 1604 and may also obtain k_{mac} through the system information. Using the parameters, the IAB-MT of the relay node 1602 may calculate the delay between the relay node 1602 and the gNB-CU 1605 through Equation 3. It can be seen that the calculated delay is equivalent to the sum of Equation 7 and Equation 8.

The relay node 1602 may provide information on the delay between the relay node 1602 and the gNB-CU 1605 to the UE through system information.

In step S1711, the terrestrial relay may broadcast synchronization signals, system information, and the like within a communication coverage. The synchronization signals may correspond to SSB and/or PBCH, and the system information may refer to various system information such as SIB1 and SIBx. In the present disclosure, SIBx may be a newly defined SIB for NTN relay nodes or an existing SIB extended to include information for NTN relay nodes. SIBx may include information on the delay between the terrestrial CU and the terrestrial relay (DU), calculated using Equations 7 and 8.

Additionally, SIBx may include relay node type information. The relay node type information may indicate whether the terrestrial relay supports NTN connectivity and whether the satellite connected to the relay is a transparent satellite or a regenerative satellite. The relay node type information may be indicated explicitly, as described above, or implicitly. For example, if the RTT between the relay node and the terrestrial CU included in SIBx is not 0, this may implicitly indicate that the relay node is an NTN relay.

In step S1711, the UE may receive the synchronization signals, system information, and the like from the relay node. The UE may acquire downlink synchronization with the relay node based on the received synchronization signals and may identify the relay node type information from the received system information. If the UE is unable to decode the received SIBx, the UE is unable to access the terrestrial relay for NTN connectivity.

As another method to restrict UE access, a cell barring indication in SIB1 may be used to restrict access. By blocking UEs that are unable to connect to the NTN through the relay described in the present disclosure, unnecessary RACH procedures can be prevented.

In step S1721, the UE may transmit Msg1 to the relay node. At this time, the UE may be a UE that has obtained the RTT between the relay node and the terrestrial CU through SIBx among the system information received from the relay node. In other words, the UE may be a UE that has decoded SIBx or is not subject to cell barring. When transmitting Msg1, the UE may determine T_{TA} using Equation 1, as in the existing terrestrial network, and may set the N_{TA} to 0.

In step S1721, the relay node may receive Msg1 transmitted by the UE. In step S1721, Msg1 received by the relay node may have been transmitted by the UE without any compensation. Therefore, the relay node that received Msg1 transmitted by the UE may estimate N_{TA} based on the received Msg1.

In step S1722, the relay node may respond to Msg1 received from the UE by transmitting Msg2 to the UE. Msg2 may be an RAR. Msg2 may include N_{TA} estimated by the base station and may also include uplink grant information. The uplink grant information may refer to uplink resource allocation information.

In step S1722, the UE may receive Msg2 from the relay node. The UE may receive Msg2 within an RAR window 1701 at a time of Msg2 reception. At this time, as illustrated in FIG. 17, the RAR window 1701 may exist without any shift applied to the RAR window. Since the relay node is located on the ground, Msg2 may be received from the terrestrial relay node within the RAR window 1701 in the same manner as in the TN. Therefore, shifting of the RAR window may not be required. The UE receiving Msg2 may obtain N_{TA} estimated by the relay node and the uplink grant information. Additionally, N_{TA} may be updated by a MAC-CE.

In step S1723, the UE may transmit Msg3 to the terrestrial relay to resolve contention. Since the terrestrial relay only has the DU function, the terrestrial relay node may forward Msg3 to the terrestrial CU via the satellite DU. As illustrated in FIG. 17, the delay between the UE and the terrestrial relay may be a delay in the terrestrial section, the delay between the terrestrial relay and the satellite DU may be a service link delay, and the delay between the satellite DU and the terrestrial CU may be a feeder link delay. Therefore, Msg3 may experience delays through the terrestrial section, service link, and feeder link. Here, Msg3 may be transmitted based on the uplink grant information included in Msg2. Additionally, Msg3 may include a UE ID and an RRC setup request.

In step S1723, the terrestrial CU may receive Msg3 transmitted by the UE via the relay node and the satellite DU, and may obtain the UE ID and the RRC setup request included in Msg3.

In step S1724, the terrestrial CU may transmit Msg4 to the UE via the satellite DU and the terrestrial relay.

In step S1724, the UE may receive Msg4 transmitted by the terrestrial CU via the terrestrial relay. At this time, a contention resolution window 1702 for receiving Msg4 may be shifted by the RTT 1712 between the terrestrial relay and the terrestrial CU, as received from SIBx.

In the configuration exemplified in FIGS. 16 and 17, when the UE transmits messages (or data) of the RRC layer and/or the PDCP layer, the RTT 1712 between the terrestrial relay and the terrestrial CU is applied. However, for data transmission below L2, transmission may proceed in the same manner as in the TN. In other words, values such as K_{offset} and k_{mac} are not applied during communication between the terrestrial UE and the terrestrial relay node. In this architecture, k_{mac} may be set equal to the RTT between the reference point on the feeder link and the terrestrial CU, as described earlier, may also be used to calculate the RTT between the satellite DU and the terrestrial CU, as shown in Equation 7, but it may not be used to delay an application time of a configuration indicated by a MAC CE command received through a PDSCH.

In a network such as the one shown in FIGS. 16 and 17, when the UE uses the RRC layer and/or PDCP protocol, there may be cases where a timer or window needs to be extended by the RTT between the terrestrial relay and the terrestrial CU. Therefore, if the RTT between the terrestrial relay and the terrestrial CU changes after initial access, the updated RTT needs to be provided to the UE. This provision may be made through an extended MAC CE or a newly defined MAC CE.

The extended MAC CE may correspond to a case where a MAC CE field is extended (or redefined) to include the updated RTT when the RTT between the relay node and the terrestrial CU changes. The newly defined MAC CE may include a field for delivering the updated RTT along with a command to update the RTT when the RTT between the relay node and the terrestrial CU changes. Through this, the updated RTT between the relay node and the terrestrial CU may be provided to the UE.

As described above, providing the RTT between the relay node and the terrestrial CU to a non-NTN UE without NTN functionality via the NTN relay node has the advantage of allowing the non-NTN UE to easily utilize the NTN environment.

If an NTN UE uses the NTN via the relay node, the NTN UE may communicate through the NTN in the same manner as the non-NTN UE described above if it can decode SIBx. To enable the NTN UE to communicate via the relay node, the terrestrial relay node may broadcast SIB19, which includes satellite-related information. Accordingly, the NTN UE may receive SIB19 from the relay node, calculate delays from delay-related parameters, and operate as described above by performing calculations in the same manner as described above.

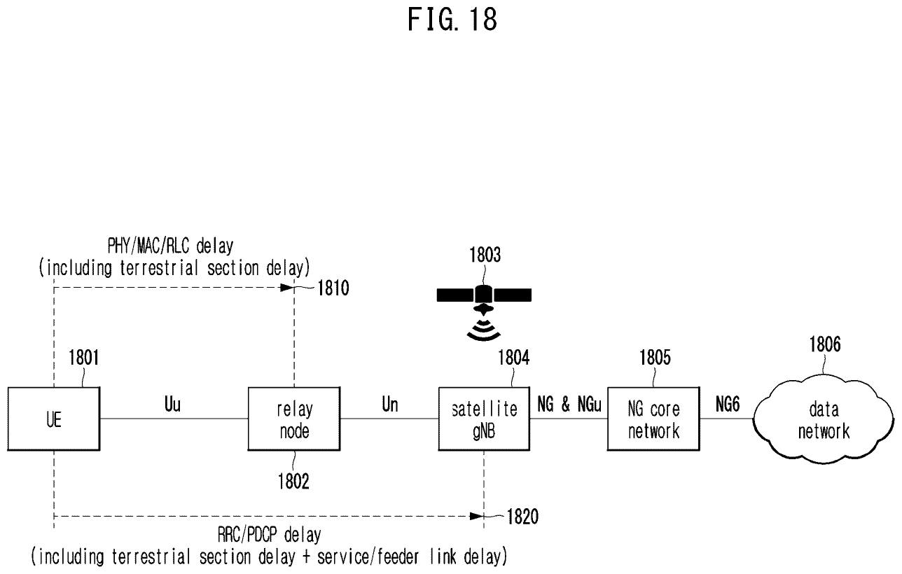

FIG. 18 is a conceptual diagram illustrating delays when a UE communicates with an NTN via a relay node in a case where a satellite in the NTN includes a full gNB.

Referring to FIG. 18, a UE 1801 without NTN functionality, a relay node 1802, a satellite 1803, a satellite gNB 1804 mounted on (or included in) the satellite, an NG core network 1805, and a data network 1607. The architecture illustrated in FIG. 18 may correspond to the configuration described in FIG. 9B. A difference between FIG. 18 and the previously described FIG. 9B is that the relay node 1802 is configured as an IAB node including a DU, and the full satellite gNB 1804 may serve as an IAB donor including both a CU and a DU.

The example of FIG. 18, compared to FIGS. 14 and 15, may be understood similarly to the case where a UE communicates via a relay node in the NTN architecture using the transparent satellite of FIG. 14, except that there is no feeder link delay to the satellite gNB 1804.

Since the relay node 1802 is located on the ground and the UE 1801 is also located on the ground, a delay 1810 between the UE 1801 to the relay node 1802 may be the same as a delay in TN. Additionally, since the relay node 1802 is an IAB node performing the DU function, the delay 1810 between the UE 1801 and the relay node 1802 may be a delay in the PHY layer/MAC layer/RLC layer, as described in the IAB architecture. In other words, the delay 1810 between the UE 1801 and the relay node 1802 may be an RTD of the PHY layer/MAC layer/RLC layer.

On the other hand, a processing delay 1820 of the RRC layer/PDCP layer may include a terrestrial section RTD and a service link RTD from the relay node 1802 to the satellite 1803.

Therefore, in the case of FIG. 18, since processing delays for Msg1 and Msg2 and processing delays for Msg3 and Msg4 in a random access procedure differ, different values may need to be used for shifting an RAR window and a contention resolution window.

The relay node 1802 illustrated in FIG. 18 may be divided into an IAB MT and an IAB DU. The IAB DU of the relay node 1802 may have a functionality to communicate with the UE 1801 and may not have NTN functionality. On the other hand, the IAB MT of the relay node 1802 may have NTN functionality to connect to the satellite. Additionally, when the UE 1801 transmits and receives data of the PHY layer/MAC layer/RLC layer with the relay node 1802, communication may proceed in the same manner as when connecting to the TN, even if the UE 1801 does not have NTN functionality. Therefore, since the processing delays for Msg1 and Msg2 are delays in the terrestrial section, it may not be required to shift the RAR window as in the TN. In other words, since the UE 1801 and the relay node 1802 operate in the terrestrial section, the RAR window may be configured in the same manner as in the TN.

On the other hand, for processing Msg3 and Msg4 in the random access procedure, data processing at the RRC layer and/or PDCP layer is required, so the UE 1801 may need to know information on an NTN delay, which differs from the TN delay. In FIG. 18, since the satellite 1803 includes the satellite base station 1804, the delays for Msg3 and Msg4 processed in the RRC layer may only include a service link. Therefore, the UE 1801 may need to be aware of the service link delay. Accordingly, the satellite base station 1804 may need to inform the UE 1801 of information on the delay of the RRC layer/PDCP layer to ensure that the UE 1801 applies an appropriate delay when transmitting messages (or data) at the RRC layer/PDCP layer. Through this, even the UE 1801 that does not support NTN can access the NTN via the relay node 1802 if it can process this information.

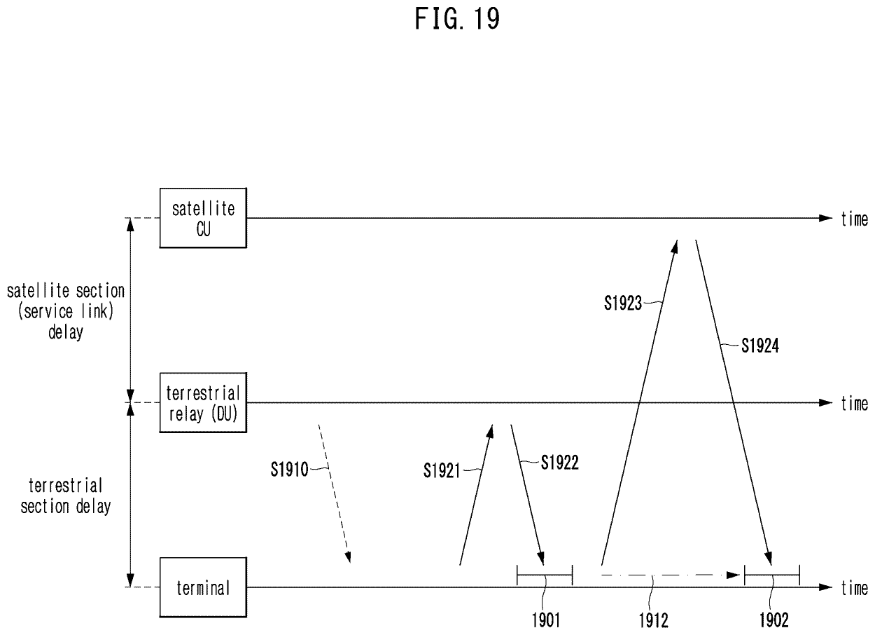

FIG. 19 is a timing diagram illustrating a procedure for a UE to perform random access via a relay node in an NTN architecture where a satellite includes a full gNB.

The timing diagram in FIG. 19 may correspond to an example of a random access procedure for the configuration described in FIG. 18. Therefore, the relay node may perform the DU function as described in FIG. 18, and the satellite may include a full gNB, including both CU and DU. Accordingly, the satellite may include (or be equipped with) a satellite gNB.

In step S1910, the terrestrial relay may broadcast synchronization signals, system information, and the like within a communication coverage. The synchronization signals may correspond to SSB and/or PBCH, and the system information may refer to various system information such as SIB1 and SIBx. In the present disclosure, SIBx may be a newly defined SIB for NTN relay nodes or an existing SIB extended to include information for NTN relay nodes. SIBx may include information on a delay between the satellite CU and the terrestrial relay (DU). In other words, SIBx may include information such as a service link delay between the terrestrial NTN relay (DU) and the satellite CU. The RTT between the terrestrial relay and the satellite CU may be calculated as shown in Equation 9 below.

$$RTT between terrestrial relay and satellite CU = ( {N}_{TA} + {N}_{TA , offset} + {N}_{TA , adj}^{UE} ) \times {T}_{c} \qquad [ Equation 9 ]$$

Referring to Equation 9, it can be seen that since a feeder link delay is not included, the parameter N_{TA,adj}^{common} does not exist. Additionally, it can be seen that the parameter k_{mac} also does not exist. Furthermore, all parameters used in Equation 9 may be parameters between the IAB-MT of the terrestrial relay (DU) and the satellite CU.

Since the terrestrial relay (DU) has NTN UE functionality, the terrestrial relay may be able to calculate Equation 9, and after calculating the RTT between the terrestrial relay and the satellite CU, may deliver the calculated RTT to non-NTN terrestrial UEs that do not support NTN functionality through broadcasting via SIBx transmitted by the terrestrial IAB-DU.

Additionally, as described above, SIBx may further include relay node type information. The relay node type information may indicate whether the terrestrial relay supports NTN connectivity and whether the satellite connected to the relay is a transparent satellite or a regenerative satellite. The relay node type information may be explicitly indicated as described above or implicitly provided. For example, if the RTT between the relay node and the satellite CU included in SIBx is not 0, this may implicitly indicate that the relay node is an NTN relay.

In step S1910, the UE may receive the synchronization signals, system information, and the like from the relay node. The UE may acquire downlink synchronization with the relay node based on the received synchronization signals and may identify the relay node type information from the received system information. If the UE is unable to decode the received SIBx, the UE may be unable to connect to the terrestrial relay for NTN connectivity.

As another method to restrict UE access, a cell barring indication in SIB1 may be used to restrict access. By blocking UEs that are unable to connect to the NTN via the relay described in the present disclosure, unnecessary RACH procedures can be prevented.

In step S1921, the UE may transmit Msg1 to the relay node. At this time, the UE may be a UE that has obtained the RTT between the terrestrial relay node and the satellite CU through SIBx in the system information received from the relay node. In other words, the UE may be a UE that has decoded SIBx or is not subject to cell barring. When transmitting Msg1, the UE may determine T_{TA} using Equation 1, as in the existing terrestrial network, and may set N_{TA} to 0 when transmitting Msg1.

In step S1921, the relay node may receive Msg1 transmitted by the UE. Msg1 received by the relay node in step S1921 may have been transmitted by the UE without any compensation. Therefore, the relay node that received Msg1 transmitted by the UE may estimate N_{TA} based on the received Msg1.

In step S1922, the relay node may respond to Msg1 received from the UE by transmitting Msg2 to the UE. Msg2 may be an RAR. Msg2 may include N_{TA} estimated by the base station and may also include uplink grant information. The uplink grant information may refer to uplink resource allocation information.

In step S1922, the UE may receive Msg2 from the relay node. The UE may receive Msg2 within an RAR window 1901 at a time of Msg2 reception. At this time, as illustrated in FIG. 19, the RAR window 1901 may exist without any shift applied to the RAR window. Since the relay node is located on the ground, Msg2 may be received from the terrestrial relay node within the RAR window 1901 in the same manner as in the TN. Therefore, shifting of the RAR window may not be required. The UE receiving Msg2 may obtain N_{TA} estimated by the relay node and the uplink grant information. Additionally, N_{TA} may be updated by a MAC-CE.

In step S1923, the UE may transmit Msg3 to the terrestrial relay to resolve contention. Since the terrestrial relay only has the DU function, it may forward Msg3 to the satellite CU. As illustrated in FIG. 19, a delay between the UE and the terrestrial relay may be a delay in the terrestrial section, and a delay between the terrestrial relay and the satellite CU may be a service link delay. Therefore, Msg3 may experience delays through the terrestrial section and the service link. Here, Msg3 may be transmitted based on the uplink grant information included in Msg2. Additionally, Msg3 may include a UE ID and an RRC setup request.

In step S1923, the satellite CU may receive Msg3 transmitted by the UE via the relay node and obtain the UE ID and the RRC setup request included in Msg3.

In step S1924, the satellite CU may transmit Msg4 to the UE via the terrestrial relay node.

In step S1924, the UE may receive Msg4 transmitted by the satellite CU via the terrestrial relay. At this time, a contention resolution window 1902 for receiving Msg4 may be shifted by an RTT 1912 between the terrestrial relay and the satellite CU, as obtained from SIBx.

For the UE configured as in FIGS. 18 and 19, data transmission below L2 with the terrestrial relay node may proceed in the same manner as in the TN. In other words, values such as K_{offset} and k_{mac} may not be applied during communication between the terrestrial UE and the terrestrial relay node.

On the other hand, for communication using the RRC layer and/or the PDCP protocol, the UE may need to extend its timer or window by the RTT between the terrestrial relay and the satellite CU. Therefore, if the RTT between the terrestrial relay and the satellite CU changes after initial access, the satellite CU may need to provide the updated RTT to the UE via the relay node. The updated RTT may be provided to the UE through an extended MAC CE or a newly defined MAC CE.

The extended MAC CE may correspond to a case where a MAC CE field is extended (or redefined) to include the updated RTT when the RTT between the terrestrial relay node and the satellite CU changes. The newly defined MAC CE may include a field for delivering the updated RTT along with a command to update the RTT when the RTT between the terrestrial relay node and the satellite CU changes. Through this, the updated RTT between the relay node and the satellite CU may be provided to the UE.

As described above, by providing the RTT between the relay node and the satellite CU to non-NTN UEs without NTN functionality via the NTN relay node, the non-NTN UEs can also easily utilize the NTN environment.

If an NTN UE uses the NTN via the relay node, the NTN UE may communicate through the NTN in the same manner as the non-NTN UE described above if it can decode SIBx. To enable the NTN UE to communicate via the relay node, the terrestrial relay node may broadcast SIB19, which includes satellite-related information. Accordingly, the NTN UE may receive SIB19 from the relay node, calculate delays from delay-related parameters, and operate as described above by performing calculations in the same manner as described above.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving a synchronization signal block (SSB) and system information (SI) from a first communication node of a non-terrestrial network;
estimating a first round trip time (RTT) between the UE and the first communication node;
transmitting, to the first communication node, a first message (Msg1) below a layer 2 at a first transmission time based on a type of the first communication node indicated by the SI and the first RTT;
in response to the type of the first communication node being a regenerative satellite in form of a base station distributed unit (DU), shifting a first window for receiving a second message (Msg2) responding to the Msg1 by the first RTT; and
receiving, from the first communication node, the Msg2 including timing advance (TA) information based on measurement of the Msg1 and uplink grant information within the shifted first window.

2. The method according to claim 1, wherein the first RTT is calculated based on at least: a first parameter based on a delay between the first communication node and a reference point (RP), a UE-specific TA value obtained based on an ephemeris-related parameter broadcast by the satellite and location information of the UE, a TA offset, or a second parameter for alignment of an uplink radio frame and a downlink radio frame, which is broadcast by the satellite.

3. The method according to claim 1, further comprising:
in response to the type of the first communication node being a regenerative satellite in form of a base station DU, transmitting, to a terrestrial base station central unit (CU), a third message (Msg3) including a radio resource control (RRC) layer message via the first communication node based on the uplink grant information;
calculating a second RTT between the UE and the terrestrial base station CU based on the SI or the Msg2;
shifting a second window for receiving a fourth message (Msg4) responding to the Msg3 by the second RTT; and
receiving the Msg4 within the second window shifted by the second RTT.

4. The method according to claim 3, wherein the second RTT is calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the first communication node.

5. The method according to claim 1, further comprising:
in response to the type of the first communication node being a satellite including a full base station, shifting a first window for receiving an Msg2 responding to the Msg1 by the first RTT; and
receiving the Msg2 within the shifted first window from the first communication node.

6. The method according to claim 5, further comprising:
in response to the type of the first communication node being a satellite including a full base station; transmitting, to the first communication node, an Msg3 including an RRC layer message based on the uplink grant information;
shifting a second window for receiving an Msg4 responding to the Msg3 by the first RTT; and
receiving the Msg4 within the second window shifted by the first RTT.

7. The method according to claim 1, further comprising: in response to the type of the first communication node being a terrestrial relay node operating as a base station DU, receiving the Msg2 within the first window for receiving the Msg2.

8. The method according to claim 7, further comprising:
in response to the type of the first communication node being a terrestrial relay node operating as a base station DU, transmitting, to a base station CU, an Msg3 including an RRC layer message via the first communication node based on the uplink grant information;
calculating a second RTT between the UE and the base station CU based on the SI or the Msg2;
shifting a second window for receiving an Msg4 responding to the Msg3 by the second RTT; and
receiving the Msg4 within the second window shifted by the second RTT.

9. The method according to claim 8, wherein the second RTT is calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the satellite.

10. A user equipment (UE) comprising at least one processor, wherein the at least one processor causes the UE to perform:
receiving a synchronization signal block (SSB) and system information (SI) from a first communication node of a non-terrestrial network;
estimating a first round trip time (RTT) between the UE and the first communication node;
transmitting, to the first communication node, a first message (Msg1) below a layer 2 at a first transmission time based on a type of the first communication node indicated by the SI and the first RTT;
in response to the type of the first communication node being a regenerative satellite in form of a base station distributed unit (DU), shifting a first window for receiving a second message (Msg2) responding to the Msg1 by the first RTT; and
receiving, from the first communication node, the Msg2 including timing advance (TA) information based on measurement of the Msg1 and uplink grant information within the shifted first window.

11. The UE according to claim 10, wherein the first RTT is calculated based on at least: a first parameter based on a delay between the first communication node and a reference point (RP), a UE-specific TA value obtained based on an ephemeris-related parameter broadcast by the satellite and location information of the UE, a TA offset, or a second parameter for alignment of an uplink radio frame and a downlink radio frame, which is broadcast by the satellite.

12. The UE according to claim 10, wherein the at least one processor further causes the UE to perform:
in response to the type of the first communication node being a regenerative satellite in form of a base station DU, transmitting, to a terrestrial base station central unit (CU), a third message (Msg3) including a radio resource control (RRC) layer message via the first communication node based on the uplink grant information;
calculating a second RTT between the UE and the terrestrial base station CU based on the SI or the Msg2;
shifting a second window for receiving a fourth message (Msg4) responding to the Msg3 by the second RTT; and
receiving the Msg4 within the second window shifted by the second RTT.

13. The UE according to claim 12, wherein the second RTT is calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the first communication node.

14. The UE according to claim 10, wherein the at least one processor further causes the UE to perform:
in response to the type of the first communication node being a satellite including a full base station, shifting a first window for receiving an Msg2 responding to the Msg1 by the first RTT; and
receiving the Msg2 within the shifted first window from the first communication node.

15. The UE according to claim 14, wherein the at least one processor further causes the UE to perform:
in response to the type of the first communication node being a satellite including a full base station; transmitting, to the first communication node, an Msg3 including an RRC layer message based on the uplink grant information;
shifting a second window for receiving an Msg4 responding to the Msg3 by the first RTT; and
receiving the Msg4 within the second window shifted by the first RTT.

16. The UE according to claim 10, wherein the at least one processor further causes the UE to perform: in response to the type of the first communication node being a terrestrial relay node operating as a base station DU, receiving the Msg2 within the first window for receiving the Msg2.

17. The UE according to claim 16, wherein the at least one processor further causes the UE to perform:
in response to the type of the first communication node being a terrestrial relay node operating as a base station DU, transmitting, to a base station CU, an Msg3 including an RRC layer message via the first communication node based on the uplink grant information;
calculating a second RTT between the UE and the base station CU based on the SI or the Msg2;
shifting a second window for receiving an Msg4 responding to the Msg3 by the second RTT; and
receiving the Msg4 within the second window shifted by the second RTT.

18. The UE according to claim 17, wherein the second RTT is calculated based on at least: the TA information, an offset for correction of the TA information, a first parameter based on a delay between the satellite and an RP, a UE-specific TA value obtained based on an ephemeris-related parameter broadcast by the satellite and location information of the UE, or a second parameter for alignment of an uplink radio frame and a downlink radio frame, which is broadcast by the satellite.

19. A method of a satellite in a non-terrestrial network, comprising:
broadcasting a synchronization signal block (SSB) and system information (SI) within a cell; and
in response to receipt of a first message (Msg1) below a second layer (layer 2) from a user equipment (UE), transmitting, to the UE, a second message (Msg2) including timing advance (TA) information based on measurement of the Msg1 and uplink grant information,
wherein the SI indicates type information of the satellite, and the type information indicates that the satellite is a regenerative satellite in form of a base station distributed unit (DU).

20. The method according to claim 19, further comprising:
in response to receipt of a third message (Msg3) including a radio resource control (RRC) layer message from the UE, forwarding the Msg3 to a terrestrial base station in form of a central unit (CU); and
in response to receipt of a fourth message (Msg4) responding to the Msg3 from the terrestrial base station in form of the CU, transmitting the Msg4 to the UE.
